(19) United States
(12) Patent Application Publication
(10) Pub. No.: US 2016/0035493 A1
(43) Pub. Date: Feb. 4, 2016

(54) MULTILAYERED STRUCTURE, CAPACITOR ELEMENT, AND FABRICATION METHOD OF THE CAPACITOR ELEMENT

(71) Applicant: ROHM CO., LTD., Kyoto-shi (JP)

(72) Inventors: Naoaki TSURUMI, Kyoto-shi (JP); Yasuo KANETAKE, Kyoto-shi (JP)

(21) Appl. No.: 14/819,060

(22) Filed: Aug. 5, 2015

Related U.S. Application Data
(63) Continuation of application No. PCT/JP2014/052748, filed on Feb. 6, 2014.

(30) Foreign Application Priority Data
Feb. 6, 2013 (JP) 2013-021414

(51) Int. Cl. H01G 4/32; F16B 25/00; H01G 4/232; H02M 7/00; H01G 4/10; H01G 4/14

(52) U.S. Cl. CPC H01G 4/32; H01G 4/10; H01G 4/14; H01G 4/232; H02M 7/003; F16B 25/00

(57) ABSTRACT

The capacitor element (20) including the multilayered structure includes: a substrate (10); a buffer layer (12) disposed on the substrate (10); a lower electrode (14) disposed on the buffer layer (12), and a dielectric layer (16) disposed on the lower electrode (14), the dielectric layer composed of nitrides. Furthermore, the capacitor element includes: an upper electrode (18) disposed on the dielectric layer (16), a first terminal electrode connected to the lower electrode (14), and a second terminal electrode connected to the upper electrode (18). There is provided a capacitor element excellent in high-temperature stability, and a fabrication method of such a capacitor element.

### CROSS REFERENCE TO RELATED APPLICATIONS

This is a continuation application (CA) of PCT Application No. PCT/JP2014/052748, filed on Feb. 6, 2014, which claims priority to Japan Patent Application No. P2013-021414 filed on Feb. 6, 2013 and is based upon and claims the benefit of priority from prior Japanese Patent Application No. P2013-021414 filed on Feb. 6, 2013 and PCT Application No. PCT/JP2014/052748, filed on Feb. 6, 2014, the entire contents of each of which are incorporated herein by reference.

### FIELD

The embodiment described herein relates to a multilayered structure, a capacitor element, and a fabrication method of the capacitor element. The embodiment relates to in particular a multilayered structure, a capacitor element, and a fabrication method of the capacitor element, each excellent in high-temperature stability.

### BACKGROUND

Laminated ceramic capacitors, electrolytic capacitors, film capacitors, etc. are known, as conventional capacitor elements.

Moreover, there has been disclosed a capacitor element having a laminated structure composed of Al/SiOₓ/BN/SiOₓ/Al on a silicon (Si) substrate.

Moreover, there has been also disclosed a capacitor element using AlN as a dielectric layer.

### SUMMARY

Since ferroelectrics, e.g. a barium titanate (BaTiO₃), are used for laminated ceramic capacitors, ferroelectric materials are phase-transited thereto at the time of high temperature operation. Accordingly, a value of capacitance is reduced at the time of the high temperature operation. On the other hand, laminated ceramic capacitors to which paraelectrics materials are applied is impervious to high temperatures, but the capacitance values thereof are relatively small. Moreover, since oxide substances are used as materials, oxygen defects occurs, and thereby reliability easily reduced.

Electrolytic capacitors contain high temperature sensitive materials, and therefore there is a problem of drying up of electrolysis solutions.

Film capacitors contain organic substances as materials, and therefore are heat-sensitive capacitors.

The embodiment provides a multilayered structure, a capacitor element, and a fabrication method of the capacitor element, each excellent in high-temperature stability.

According to one aspect of the embodiment, there is provided a multilayered structure comprising: a substrate; a buffer layer disposed on the substrate; a lower electrode disposed on the buffer layer; and a dielectric layer disposed on the lower electrode, the dielectric layer composed of nitrides.

According to another aspect of the embodiment, there is provided a capacitor element comprising: a multilayered structure comprising a substrate, a buffer layer disposed on the substrate, a lower electrode disposed on the buffer layer, a dielectric layer disposed on the lower electrode, the dielectric layer composed of nitrides, and an upper electrode disposed on the dielectric layer; a first terminal electrode connected to the lower electrode; and a second terminal electrode connected to the upper electrode.

According to still another aspect of the embodiment, there is provided a fabrication method of a capacitor element, the method comprising: pre-processing a substrate; forming a buffer layer on the substrate; forming a lower electrode on the buffer layer; forming a dielectric layer on the lower electrode, the dielectric layer composed of nitrides; and forming an upper electrode on the dielectric layer.

According to still another aspect of the embodiment, there is provided a cutting tool comprising: a multilayered structure comprising a substrate, a buffer layer disposed on the substrate, a lower electrode disposed on the buffer layer, and a dielectric layer disposed on the lower electrode, the dielectric layer composed of nitrides.

According to still another aspect of the embodiment, there is provided an inverter equipment comprising: a capacitor element comprising a multilayered structure, a first terminal electrode, and a second terminal electrode, the multilayered structure comprising a substrate, a buffer layer disposed on the substrate, a lower electrode disposed on the buffer layer, a dielectric layer disposed on the lower electrode, the dielectric layer composed of nitrides, and an upper electrode disposed on the dielectric layer, the first terminal electrode connected to the lower electrode, the second terminal electrode connected to the upper electrode, wherein the capacitor element is mounted on the inverter equipment.

According to still another aspect of the embodiment, there is provided a capacitor fabricating apparatus comprising: a material supply roller; a material winding roller; a plurality of tension rollers; a material transferred via the tension roller between the material supply roller and the material winding roller; and a vacuum chamber configured to supply a target material by sputtering from film-forming material supplying target in a film formation area on the material, wherein the sputtering process of film formation for a plurality of layers in the film formation area can be implemented with the roll-to-roll process in the vacuum chamber.

According to the embodiment, there can be provided the multilayered structure, the capacitor element, and the fabrication method of the capacitor element, each excellent in high-temperature stability.

### BRIEF DESCRIPTION OF DRAWINGS

FIG. 1 is a schematic cross-sectional structure diagram showing a multilayered structure and a capacitor element according to an embodiment.

FIG. 2 is a schematic cross-sectional structure diagram showing a multilayered structure and a capacitor element according to a modified example of the embodiment.

FIG. 3 is a schematic bird's-eye view structure diagram showing the capacitor element according to the embodiment and the modified example thereof.

FIG. 4 shows an example of a Transmission Electron Microscope (TEM) photograph of a dielectric layer, in the multilayered structure and the capacitor element according to the modified example of the embodiment.

FIG. 5 shows an example of a TEM photograph of a buffer layer, in the multilayered structure and the capacitor element according to the modified example of the embodiment.

FIG. 6 shows an example of an Atomic Force Microscope (AFM) photograph on a surface of the dielectric layer in a sample formed without forming a buffer layer, in a structure of the multilayered structure and the capacitor element according to the modified example of the embodiment.

FIG. 7 shows an example of an AFM photograph on the surface of the dielectric layer in a sample formed with forming the buffer layer, in the structure of the multilayered structure and the capacitor element according to the modified example of the embodiment.

FIG. 8 is a diagram showing a relationship between current density J (A/mm²) and an electric field E (v/μm) (an example of A: without buffer layer, B1: IrTa used for buffer layer, and B2: TiAlN is used for buffer layer) in which an upper electrode is a positive electrode (plus) and a lower electrode is a negative electrode (minus), in the structure of the multilayered structure and the capacitor element according to the modified example of the embodiment.

FIG. 9 shows an example of a Scanning Electron Microscope (SEM) photograph of a surface of Al foil in the case of applying the Al foil as a metallic substrate, in the structure of the multilayered structure and the capacitor element according to the embodiment.

FIG. 10A shows an example of a circuit configuration of the capacitor element, which is an example of a single element, according to the embodiment.

FIG. 10B shows an example of the circuit configuration of the capacitor element, which is an example of parallel connection configuration, according to the embodiment.

FIG. 10C shows an example of the circuit configuration of the capacitor element according to the embodiment, which is an example of a series parallel connection configuration.

FIG. 11 shows an example of a prototype photograph of the element capacitor formed on a metallic foil (electrode size: 65 mm×20 mm), in the capacitor element according to the embodiment.

FIG. 12 shows an example of frequency characteristics of a capacitance C of the capacitor element formed on the metallic foil, in the capacitor element according to the embodiment.

FIG. 13 shows an example of temperature characteristics of the capacitance C and dielectric loss D_{f} of the capacitor element formed on the metallic foil, in the capacitor element according to the embodiment.

FIG. 14 is a schematic front surface pattern configuration diagram of element capacitors formed on the metallic foil, in the capacitor element according to the embodiment.

FIG. 15 shows an example of an external photograph of a device formed of the capacitor element with a laminating method, according to the embodiment.

FIG. 16 is a schematic bird's-eye view structure diagram in an inside of a package of the capacitor element shown in FIG. 15.

FIG. 17A is a schematic diagram for explaining an aspect that two sheets of the element capacitors are layered via a separator, in the capacitor element according to the embodiment.

FIG. 17B is a schematic cross-sectional structure diagram showing n layers of the element capacitors laminated via the separator, in the capacitor element according to the embodiment.

FIG. 18A is a process chart of pre-processing of a substrate, in a fabrication method of the capacitor element according to the embodiment.

FIG. 18B is a process chart of forming a buffer layer on the substrate, in the fabrication method of the capacitor element according to the embodiment.

FIG. 18C is a process chart of forming a lower electrode on the buffer layer, in the fabrication method of the capacitor element according to the embodiment.

FIG. 18D is a process chart of forming a dielectric layer on the lower electrode, in the fabrication method of the capacitor element according to the embodiment.

FIG. 19A is a process chart of forming an upper electrode on the dielectric layer, in the fabrication method of the capacitor element according to the embodiment.

FIG. 19B is a process chart of forming an Ni layer on the upper electrode, and an Ag layer on the Ni layer one by one, in the fabrication method of the capacitor element according to the embodiment.

FIG. 19C is a process chart of forming an Ni layer on the substrate, and an Ag layer on the Ni layer one by one, in the fabrication method of the capacitor element according to the embodiment.

FIG. 20A shows an example of an outside surface photograph of the capacitor element according to the embodiment.

FIG. 20B is a schematic front surface pattern configuration diagram of the capacitor element according to the embodiment.

FIG. 21 shows an example of temperature characteristics of the rate of capacitance change ΔC (%), in the capacitor element according to the embodiment.

FIG. 22A is a front surface pattern configuration diagram of a first element capacitor, in the capacitor element according to the embodiment (example of a device made by the roll method).

FIG. 22B is a back surface pattern configuration diagram of a second element capacitor, in the capacitor element according to the embodiment (example of the device made by the roll method).

FIG. 22C is a front surface pattern configuration diagram before winding up the laminated first element capacitor and second element capacitor onto a core rod, in the capacitor element according to the embodiment (example of the device made by the roll method).

FIG. 23A is a front surface pattern configuration diagram after winding up the laminated first element capacitor and second element capacitor onto a core rod, in the capacitor element according to the embodiment (example of the device made by the roll method).

FIG. 23B shows an example of an external photograph of a wound state of the capacitor element according to the embodiment (example of the device made by the roll method).

FIG. 23C shows an example of an external photograph in a state of the capacitor element according to the embodiment being connected to external electrode terminals and housed in a case (example of the device made by the roll method).

FIG. 24 is a schematic configuration diagram showing an equipment configuration of a fabricating apparatus applicable to the fabrication method of the capacitor element according to the embodiment which can be mass-produced with a roll-to-roll method by applying the same chamber to a sputtering process.

FIG. 25 is a schematic circuit configuration diagram of a three-phase alternating current (AC) inverter equipment configured so that six power module semiconductor devices are arranged and the capacitor elements Cu, Cv, Cw according to the embodiment are mounted thereon.

FIG. 26 is a schematic circuit representative diagram of a 1-in-1 module, which is a power module semiconductor device applicable to the three-phase AC inverter equipment shown in FIG. 25.

FIG. 27 is a detail circuit representative diagram showing the 1-in-1 module.

FIG. 28 is a bird's-eye view showing a power module semiconductor device having straight wiring structure, which is a power module semiconductor device applicable to the three-phase AC inverter equipment shown in FIG. 25.

FIG. 29 is a schematic plane configuration diagram showing the power module semiconductor device having straight wiring structure.

FIG. 30 is a diagram showing an example of arranging a control substrate and a power source substrate at a upper part, in a schematic plane configuration diagram also including connection wiring (bus bar) electrodes (GNDL, POWL) between each power terminal of the three-phase AC inverter, wherein the three-phase AC inverter equipment is configured so that six power module semiconductor devices are arranged and the capacitor elements Cu, Cv, Cw according to the embodiment are mounted thereon.

FIG. 31 is a schematic cross-sectional structure diagram taken in the line I-I of FIG. 30.

FIG. 32 is a schematic bird's-eye view showing the three-phase AC inverter configured to arrange six power module semiconductor devices, in which the capacitor elements Cu, Cv, Cw according to the embodiment are mounted thereon, and the control substrate and the power source substrate are arranged thereon.

FIG. 33 shows an example of a circuit configuration in which snubber capacitors are connected to between a power supply terminal PL and a ground terminal (earth terminal) NL, in the schematic circuit configuration of the three-phase AC inverter configured so that six power module semiconductor devices are arranged and the capacitor elements Cu, Cv, Cw according to the embodiment are mounted thereon.

FIG. 34 is a schematic circuit block configuration diagram for explaining a three-phase motor drive of the three-phase AC inverter equipment configured so that six power module semiconductor devices are arranged and the capacitor elements Cu, Cv, Cw according to the embodiment are mounted thereon.

FIG. 35 is a circuit configuration diagram showing a U-phase unit in the three-phase AC inverter equipment which mounted capacitor element configured so that six power module semiconductor devices are arranged and the capacitor elements Cu, Cv, Cw according to the embodiment are mounted thereon.

FIG. 36A shows an example of a switching voltage waveform in the state where the capacitor element Cu according to the embodiment is removed from the circuit shown in FIG. 35.

FIG. 36B shows an example of a switching voltage waveform in the state where the capacitor element Cu according to the embodiment is applied thereto.

FIG. 37A is a schematic bird's-eye view of a tap screw which is a cutting tool to which a multilayered structure according to the embodiment is applied.

FIG. 37B shows a cutting tool to which the multilayered structure according to the embodiment is applied, which is a schematic cross-sectional structure diagram of the multilayered structure applicable to the tap screw shown in FIG. 37A.

### DESCRIPTION OF EMBODIMENTS

Next, the embodiment will be described with reference to drawings. In the description of the following drawings, the identical or similar reference numeral is attached to the identical or similar part. However, it should be known about that the drawings are schematic and the relation between thickness and the plane size and the ratio of the thickness of each layer differs from an actual thing. Therefore, detailed thickness and size should be determined in consideration of the following explanation. Of course, the part from which the relation and ratio of a mutual size differ also in mutually drawings is included.

Moreover, the embodiment shown hereinafter exemplifies the apparatus and method for materializing the technical idea; and the embodiment does not specify the material, shape, structure, placement, etc. of each component part as the following. The embodiment may be changed without departing from the spirit or scope of claims.

### (Multilayered Structure)

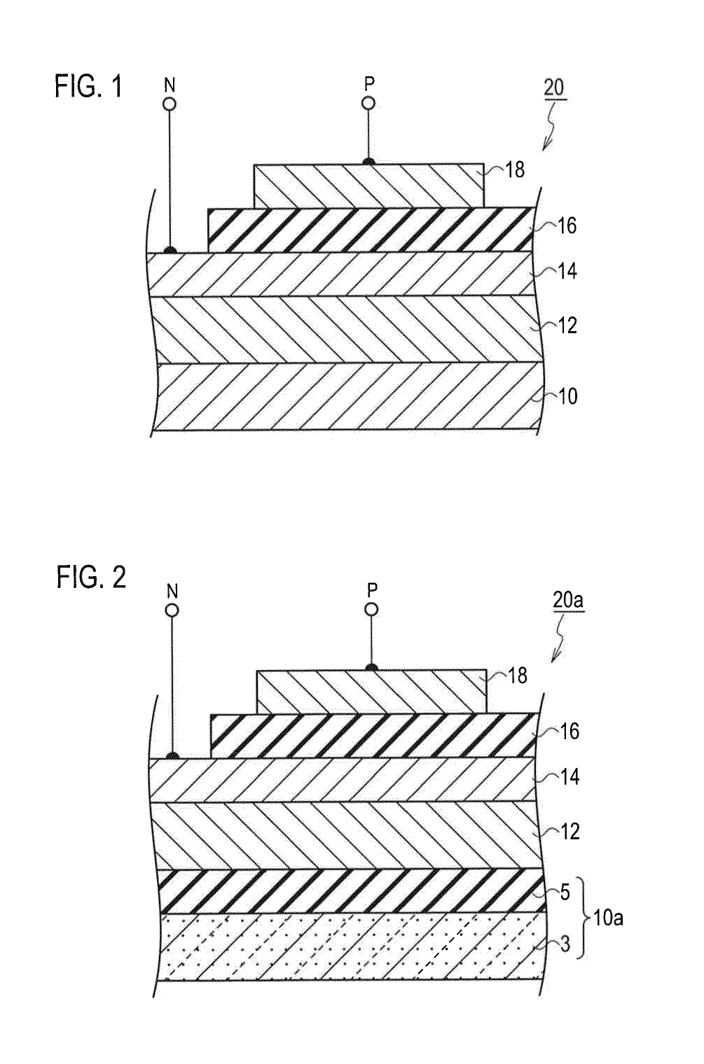

As shown in FIG. 1, a multilayered structure according to the embodiment including: a substrate 10; a buffer layer 12 disposed on the substrate 10; a lower electrode 14 disposed on the buffer layer 12; and a dielectric layer 16 disposed on the lower electrode 14, the dielectric layer 16 composed of nitrides.

In the embodiment, the buffer layer 12 may include TiAlN, IrTa, or CuTa.

Moreover, the dielectric layer 16 may include nitrogen, and may include at least one kind of boron, carbon, aluminum, or silicon.

Moreover, the dielectric layer 16 may include any one of BN, BCN, CN, BAlN, BSiN, AlN or SiN.

Moreover, the dielectric layer 16 include an amorphous layer.

Similarly, the buffer layer 12 may also include an amorphous conductor. There can be continuity between the lower electrode 14 and the metallic substrate 10 by applying the amorphous conductor to the buffer layer 12, and thereby laminated structure can easily be formed.

In the embodiment, as materials applicable to the buffer layer 12, combinations of materials which is amorphous and has electrical conductivity are as follows:

CuTa is applicable to a combination of 3d transition metals+refractory metals.

NiAg, TiAg, NiPt, and NiIr are applicable to combination of a 3d transition metals+noble metals.

IrTa and PtTa are applicable to a combination of noble metals+refractory metals.

TaSi, TaAl, WSi, MoSi, and NbB are applicable to a combination of refractory metals+semimetals.

TiAlN, TiAlB, TlSiB, NiAlN, NiAlB, and NiSiB are applicable to a combination of 3d transition metals+semimetals+nonmetals.

TaSiN and TaAlN are applicable to a combination of refractory metals+semimetals+nonmetals.

Moreover, the substrate 10 may include metallic foil, for example. As the metallic foil, it is preferably that, for example, a melting point is equal to or greater than 600 degrees C., it is easily available foil, long-term stability and high conductivity are satisfactory, and it is preferably non-magnetic substance. Metallic foils having little effect on environment or human body is preferable.

The metallic foil can be formed from any one of or any laminated structure of Ti, Ni, Cu, Mo, Al, Nb, Ta, Ag, Zr, Au, Pt, W, Ir, V, stainless-steel (SUS), 42Alloy, nickel silver, and brass. In the embodiment, the composition of the 42Alloy is Fe: approximately 57% and Ni: approximately 42%. Moreover, the composition of the nickel silver is Cu: approximately 50% to approximately 70%, Ni: approximately 5% to approximately 30%, and Zn: approximately 10% to approximately 30%. Moreover, the composition of the brass is Zn: equal to or greater than approximately 20% in Cu+Zn, for example.

Moreover, it is preferable that the lower electrode 14 can be formed by sputtering, has a high melting point and high electrical conductivity, and is a material excellent in high-temperature stability.

Cr, Mo, Al, Ta, Cu, Ti, Ni, W, or Ag is applicable to materials of the lower electrode 14, as long as it is a single metal. CuTa or TiW is applicable thereto as long as it is an alloy. Ta₂N or TIN is applicable thereto as long as it is nitride. WSi₂ or TiSi is applicable thereto as long as it is a silicide. TaB is applicable thereto as long as it is a boride.

Moreover, the multilayered structure may further include an upper electrode 18 disposed on the dielectric layer 16. Moreover, it is preferable that the upper electrode 18 can be formed by sputtering, has a high melting point and high electrical conductivity, and is a material excellent in high-temperature stability, in the same manner as the lower electrode 14.

Cr, Mo, Al, Ta, Cu, Ti, Ni, W, or Ag is applicable to materials of the upper electrode 18, as long as it is a single metal, in the same manner as the lower electrode 14. CuTa or TiW is applicable thereto as long as it is an alloy. Ta₂N or TiN is applicable thereto as long as it is nitride. WSi₂ or TiSi is applicable thereto as long as it is a silicide. TaB is applicable thereto as long as it is a boride.

As shown in FIG. 2, a multilayered structure according to a modified example of the embodiment includes: a semiconductor substrate 3; an insulating layer 5 disposed on the semiconductor substrate 3; a buffer layer 12 disposed on the insulating layer 5; a lower electrode 14 disposed on the buffer layer 12; a dielectric layer 16 disposed on the lower electrode 14, the dielectric layer 16 composed of nitrides; and an upper electrode 18 disposed on the dielectric layer 16.

In the embodiment, a silicon substrate can be applied to the semiconductor substrate 3, for example, and a silicon oxide layer can be applied to the insulating layer 5. Moreover, in the multilayered structure according to the modified example of the embodiment, it may be considered that a laminated structure composed of the insulating layer 5/the semiconductor substrate 3 correspond to a monolithic-structured substrate 10a.

A plurality of the above-mentioned multilayered structures may be laminated, in the multilayered structure according to the embodiment and the modified example thereof.

### (Capacitor Element)

As shown in FIG. 1, a capacitor element 20 according to the embodiment includes: a substrate 10; a buffer layer 12 disposed on the substrate 10; a lower electrode 14 disposed on the buffer layer 12; a dielectric layer 16 disposed on the lower electrode 14, the dielectric layer 16 composed of nitrides; and an upper electrode 18 disposed on the dielectric layer 16. In the embodiment, the lower electrode 14 and the upper electrode 18 are configure to form a main electrode of the capacitor element according to the embodiment. More specifically, as shown in FIG. 1, a positive electrode (plus) terminal P is connected to the upper electrode 18, and a negative electrode (minus) terminal N is connected to the lower electrode 14.

As shown in FIG. 2, a capacitor element 20a according to the modified example of the embodiment includes: a semiconductor substrate 3; an insulating layer 5 disposed on the semiconductor substrate 3; a buffer layer 12 disposed on the insulating layer 5; a lower electrode 14 disposed on the buffer layer 12; a dielectric layer 16 disposed on the lower electrode 14, the dielectric layer 16 composed of nitrides; and an upper electrode 18 disposed on the dielectric layer 16. In the embodiment, the lower electrode 14 and the upper electrode 18 are configure to form a main electrode of the capacitor element according to the modified example of the embodiment. More specifically, as shown in FIG. 2, a positive electrode terminal P is connected to the upper electrode 18, and a negative electrode terminal N is connected to the lower electrode 14.

In this case, a silicon substrate can be applied to the semiconductor substrate 3, for example, and a silicon oxide layer can be applied to the insulating layer 5.

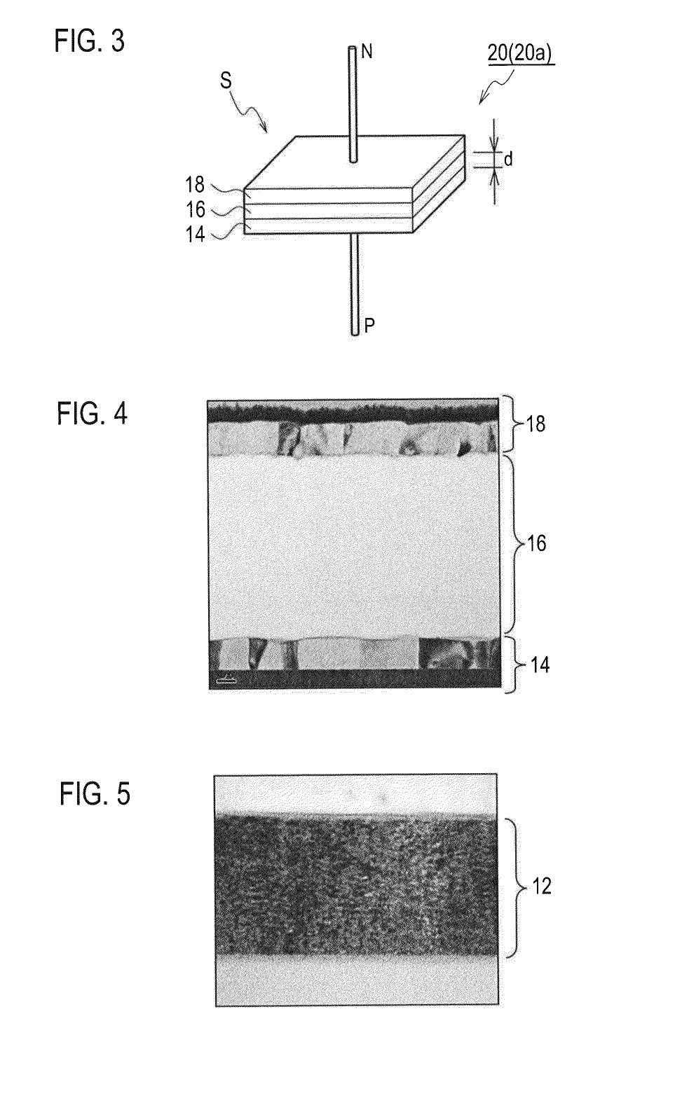

As shown in FIG. 3, the schematic bird's-eye view structure of the capacitor elements 20 (20a) according to the embodiment and the modified example thereof can be considered as the upper electrode 18 connected to the positive electrode terminal P and the lower electrode 14 connected to the negative electrode terminal N being disposed in parallel plate structure via the dielectric layer 16 of which the thickness is d. In the embodiment, an area at the opposing sides of the upper electrode 18 and the lower electrode 14 is S.

In the multilayered structure and the capacitor element according to the modified example of the embodiment, an example of a TEM photograph of the dielectric layer 16 is represented as shown in FIG. 4, and an example of a TEM photograph of the buffer layer 12 is represented, as shown in FIG. 5.

In the embodiment, the buffer layer 12 has the function of improving a property of the surface of the substrate 10, and has a favorable effect on subsequent film growth, in the multilayered structure and the capacitor element according to the embodiment. In the MIM structure of the upper electrode 18/the dielectric layer 16/the lower electrode 14, a quality of the film of the dielectric layer 16 can be improved, and thereby improving adhesibility of the MIM.

Similarly, the buffer layer 12 has the function of improving a property of the insulating layer 5 on the surface of the semiconductor substrate 3, and has a favorable effect on subsequent film growth, in the multilayered structure and the capacitor element according to the modified example of the embodiment. More specifically, in the MIM structure of the upper electrode 18/the dielectric layer 16/the lower electrode 14, a quality of the film of the dielectric layer 16 can be improved, and thereby improving adhesibility of the MIM.

The buffer layer 12 can be formed of TiAlN, IrTa, or CuTa. Moreover, it is preferable that the thickness of the buffer layer 12 is approximately 500 angstroms, and the buffer layer 12 is an amorphous layer and has a low resistivity.

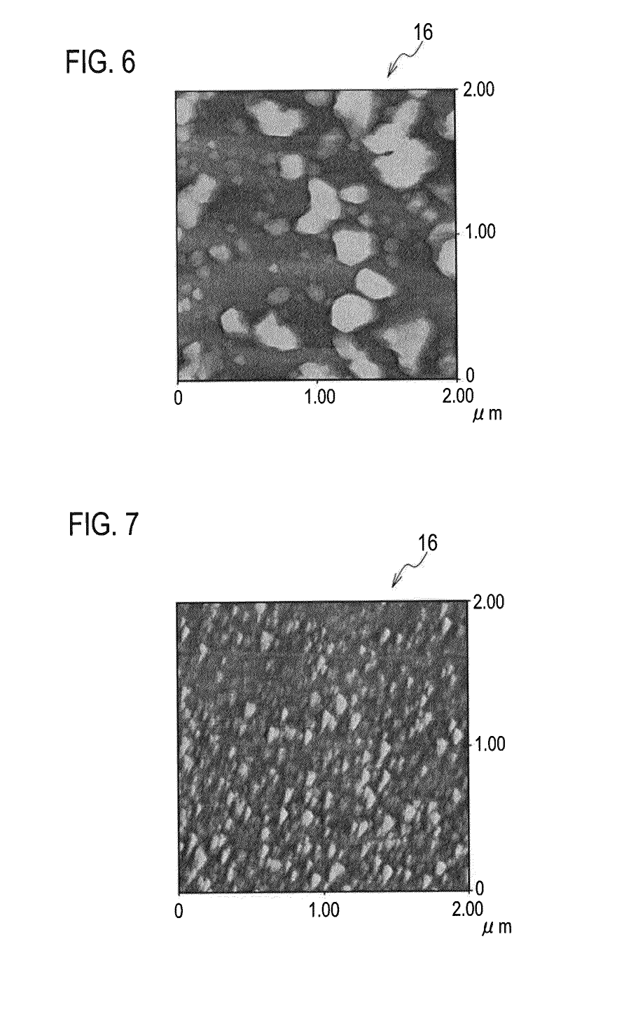

FIG. 6 shows an example of an Atomic Force Microscope (AFM) photograph on a surface of the dielectric layer 16 in a sample formed without forming a buffer layer 12, and FIG. 7 shows an example of an AFM photograph on the surface of the dielectric layer 16 in a sample formed with forming the buffer layer 12, in the structure of the multilayered structure and the capacitor element according to the modified example of the embodiment. In the example shown in FIG. 6, aggregation and sparse portions in a BN film composing the dielectric layer 16 are observed, and therefore the film quality of the dielectric layer 16 is reduced. On the other hand, in the example shown in FIG. 7, no aggregation is observed in the BN film composing the dielectric layer 16, and therefore an evenness of the BN film is improved as compared with that shown in FIG. 6.

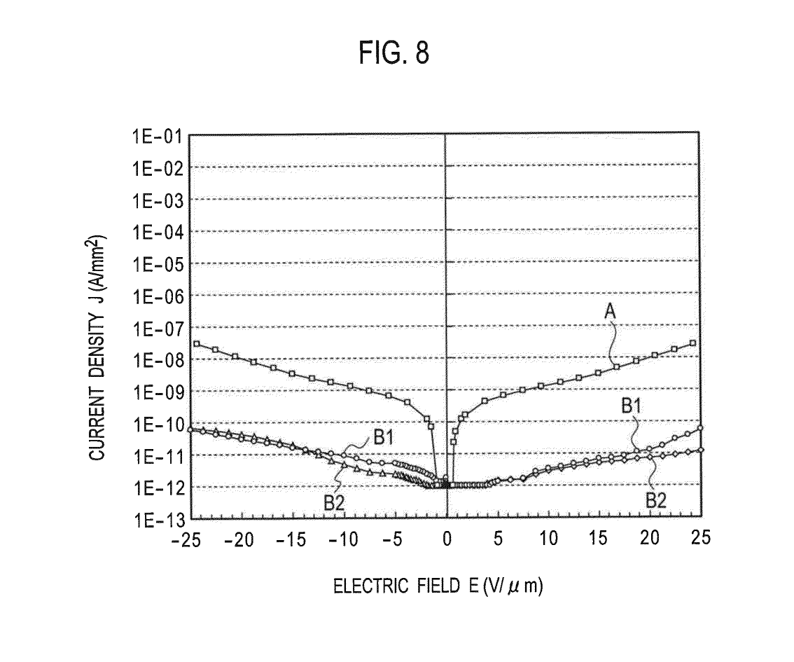

FIG. 8 shows a relationship between current density J (A/mm²) and an electric field E (v/μm) in which the upper electrode is a positive electrode (plus) and the lower electrode is a negative electrode (minus), in the structure of the multilayered structure and the capacitor element according to the modified example of the embodiment. In this case, the curved line A indicates an example of characteristics in the case of without buffer layer, the curved line B1 indicates an example of characteristics in the case of using IrTa as the buffer layer 12, and the curved line B2 indicates an example of characteristics in the case of using TiAlN as the buffer layer 12.

No remarkable difference in leakage characteristics between the forward direction and the reverse direction of the MIM structure is perceived, and leakage current density is also reduced to equal to or less than 1×10⁻¹⁰ (A/mm²). On the other hand, it is understood that leakage characteristics in the case of using no buffer layer is increased approximately equal to or greater than two digits, and therefore the film quality of the dielectric layer 16 is reduced, as compared with the leakage characteristics in both of forward direction and reverse direction of the MIM structure in the case of using IrTa as the buffer layer 12 or the case of using TiAlN as the buffer layer 12.

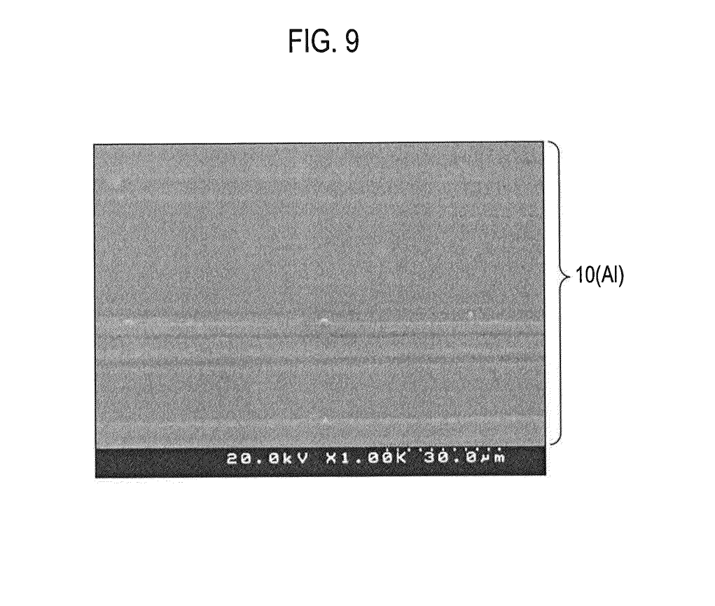

FIG. 9 shows an example of an SEM photograph of a surface of Al foil in the case of applying the Al foil as the substrate 10, in the structure of the multilayered structure and the capacitor element according to the embodiment.

In the multilayered structure and the capacitor element according to the embodiment, it is confirmed that the characteristics of the MIM structure composed of the upper electrode 18/the dielectric layer 16/the lower electrode 14 are excellent by disposing the buffer layer 12 on the substrate 10 composed of the metallic foil even if using a metallic foil having roughness or cavities etc., as the substrate.

A roll method, a multi-layering technique, etc. can be applied to the multilayered structure and the capacitor element according to the embodiment by using the metallic foil as a substrate 10 at the time of fabricating the capacitor. Moreover, the effective area can be extended so as to realize series/parallel connections. As a result, the capacitance value can be increased by the parallel connection and a breakdown voltage is improved by the series connection.

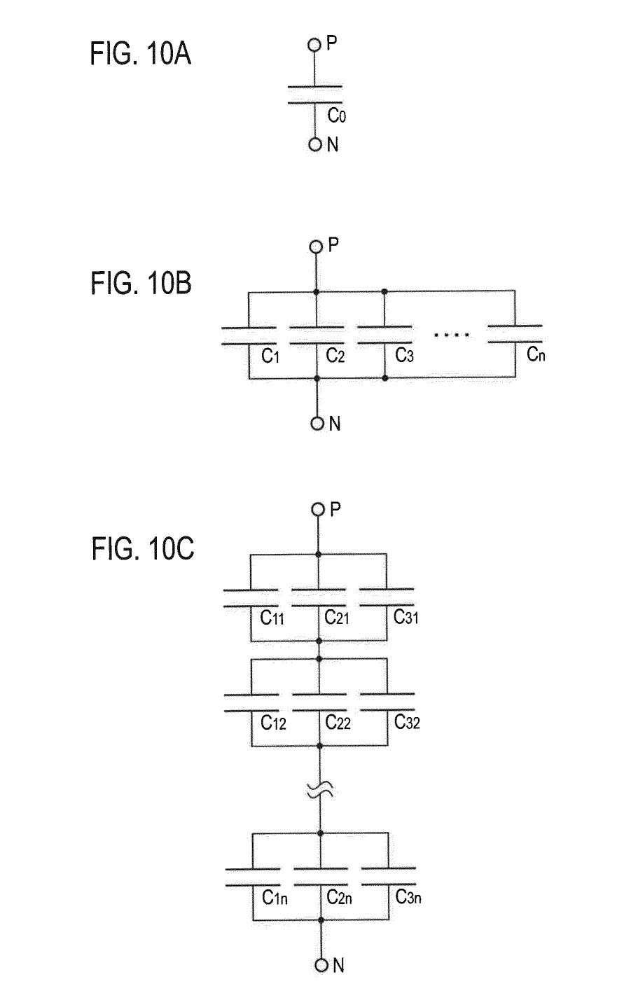

FIG. 10A shows an example of a circuit configuration of the capacitor element according to the embodiment, including a capacitor C₀, which is an example of a single element, FIG. 10B shows a configuration example of connecting capacitors C₁, C₂, . . . , Cₙ in parallel, and FIG. 10C shows a configuration example of connecting capacitors: C₁₁, C₁₂, . . . , C₁ₙ; C₂₁, C₂₂, . . . , C₂ₙ; . . . ; C₃₁, C₃₂, . . . , C₃ₙ in series parallel.

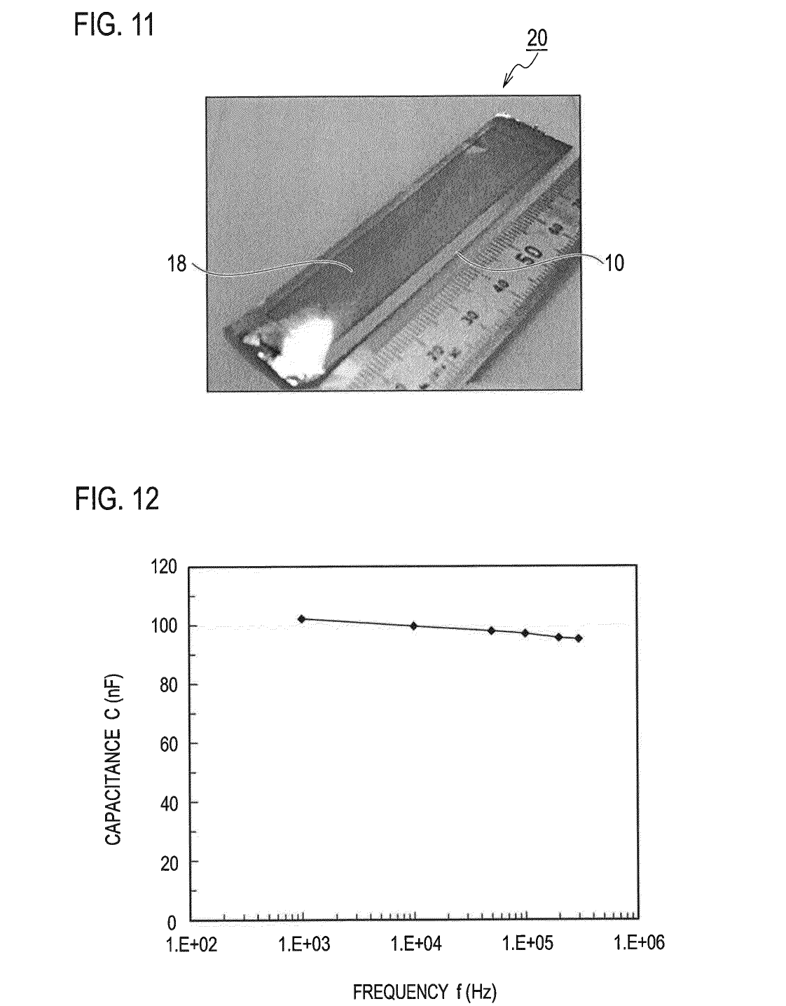

FIG. 11 shows an example photograph of a prototype formed on the substrate 10 composed of the metallic foil, in the capacitor element 20 according to the embodiment. In the embodiment, an electrode sizes of the upper electrode 18 are approximately 65 mm×approximately 20 mm.

Moreover, FIG. 12 shows an example of frequency characteristics of capacitance C of the capacitor element according to the embodiment formed on the metallic foil. In the embodiment, the capacitor element of which the capacitance value is greater than 0.1 μF on a large area can be realized by forming the buffer layer 12. In the example of characteristics shown in FIG. 12, the capacitance value C (nF) is approximately constant which is 0.1 μF up to the frequency of approximately f=300 kHz.

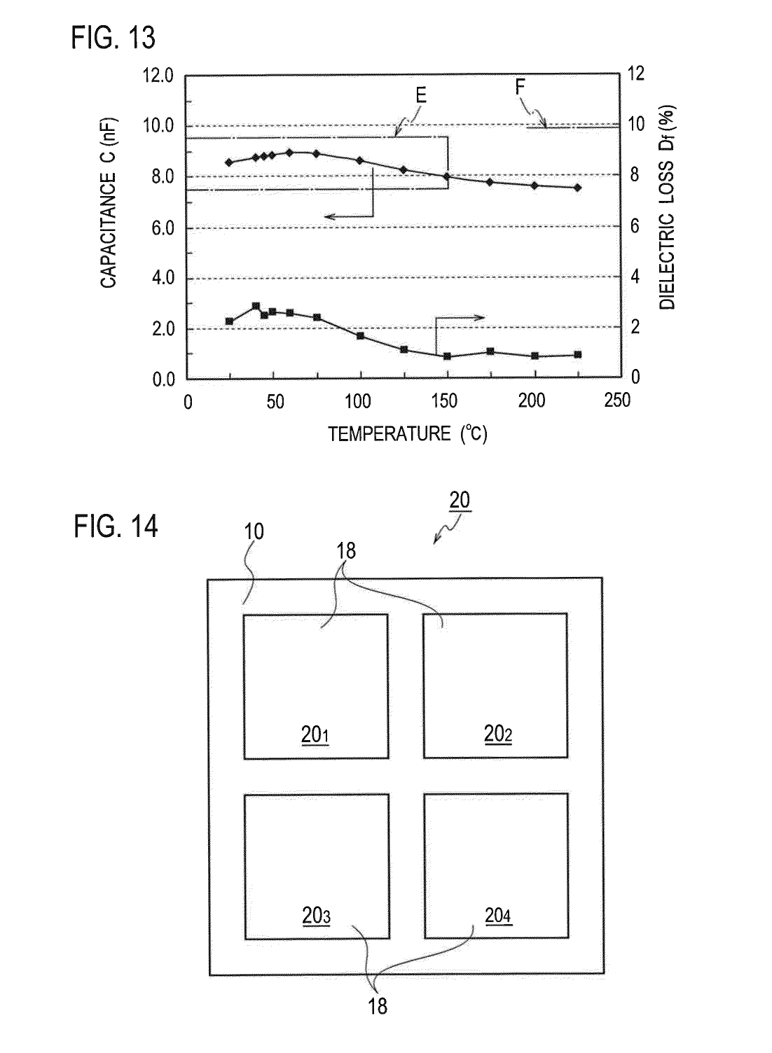

FIG. 13 shows an example of temperature characteristics of capacitance C and dielectric loss D_{f} in the capacitor element according to the embodiment formed on the metallic foil. Moreover, FIG. 14 shows a schematic front surface pattern configuration of the capacitor element 20 used for measurement. A size of each upper electrode 18 of a plurality of the element capacitors 20₁, 20₂, 20₃, 20₄ fabricated on the metallic substrate 10 is approximately 10 mm squares.

In the capacitor element according to the embodiment shown in FIG. 13, an amount of variation of the capacitance value C is small and the dielectric loss D_{f} is also stable, from room temperature to approximately 225 degrees C.

The region E shown in FIG. 13 indicates capacity deviation within a range of plus/minus 10% up to 150 degrees C. As shown in FIG. 13, the capacitor element according to the embodiment falls capacity deviation within a range of plus/minus 10% up to approximately 225 degrees C.

The dashed line F shown in FIG. 13 indicates 10% of level as a specification of the dielectric loss D_{f}. As shown in FIG. 13, in the capacitor element according to the embodiment, a value of the dielectric loss D_{f} is equal to or less than approximately 3% within a range from room temperature to the 225 degrees C.

### (Example of Device Made by Laminating Method)

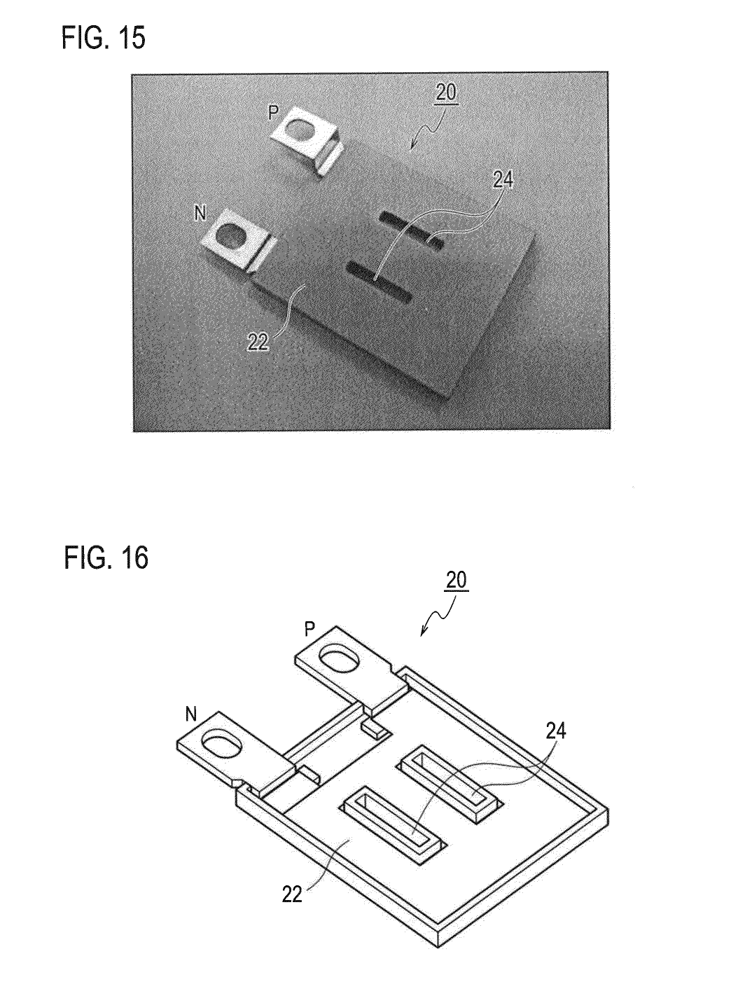

FIG. 15 shows an example of an external photograph of a device formed of the capacitor element 20 with a laminating method, according to the embodiment. FIG. 16 shows a schematic bird's-eye view structure in an inside of a package of the capacitor element 20 shown in FIG. 15. For example, as for the package size except an electrode terminal portion, the length is approximately 39 mm, the width is approximately 33 mm, and the thickness is approximately 3 mm.

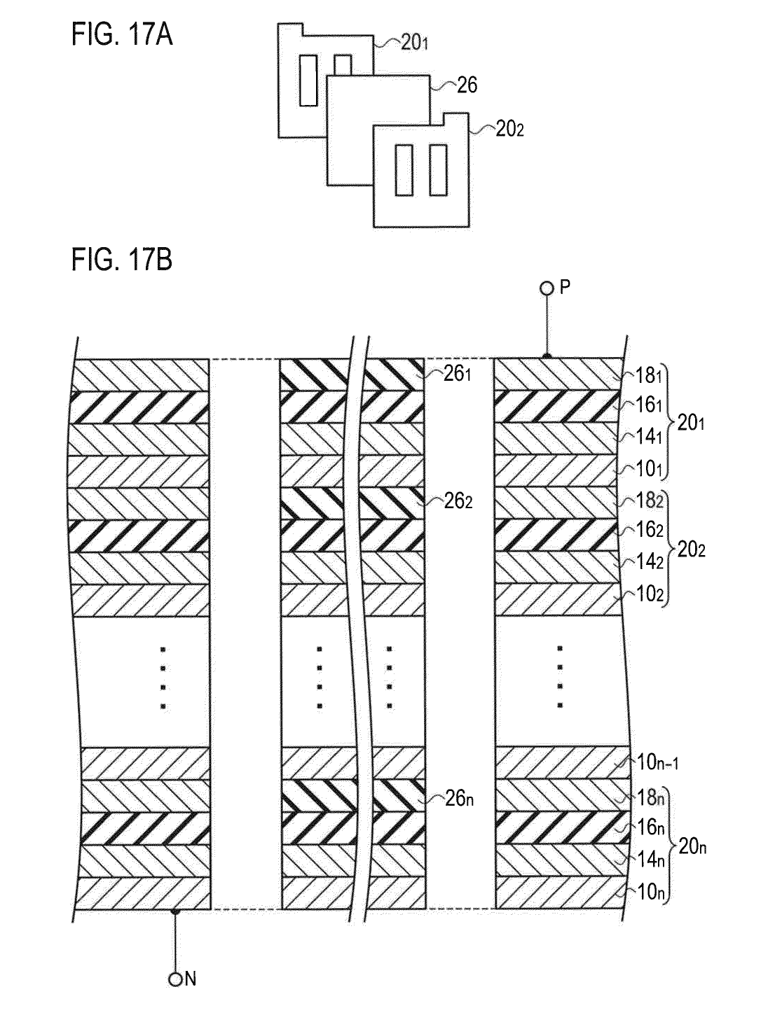

FIG. 17A shows an aspect that two sheets of the element capacitors 20₁, 20₂ are layered via a separator 26, in the capacitor element according to the embodiment.

Moreover, FIG. 17B shows a schematic cross-sectional structure in which n layers of the element capacitors 20₁, 20₂, . . . , 20ₙ respectively are laminated via the separators 26₁, 26₂, . . . , 26ₙ, in the capacitor element according to the embodiment. Although buffer layers 12₁, 12₂, . . . , 12ₙ are actually disposed between the metallic substrates 101, 102, . . . , 10n and the lower electrodes 14₁, 14₂, . . . , 14ₙ, illustration thereof is omitted in FIG. 17B.

In FIG. 16, the capacitor bodies respectively are laminated to be formed via the separators, as shown in FIGS. 17A and 17B. A resin layer 22 is formed of a heat-resistant resin. Both casing structure and molding structure can be adopted for a mounting structure of the capacitor element 20 according to the embodiment.

As shown in FIGS. 17A and 17B, the capacitor element 20 according to the embodiment may include a plurality of the element capacitors 20₁, 20₂, . . . , 20ₙ, and the plurality of the element capacitors 20₁, 20₂, . . . , 20ₙ may be laminated to be mutually connected in series so that the separators 26₁, 26₂, . . . , 26ₙ are respectively inserted therebetween.

Moreover, the capacitor element 20 according to the embodiment may have a plurality of the element capacitors, and the element capacitors may be mutually connect in parallel.

Moreover, in the capacitor element 20 according to the embodiment, the element capacitors mutually connected in series may further be mutually connected in parallel.

### (Fabrication Method)

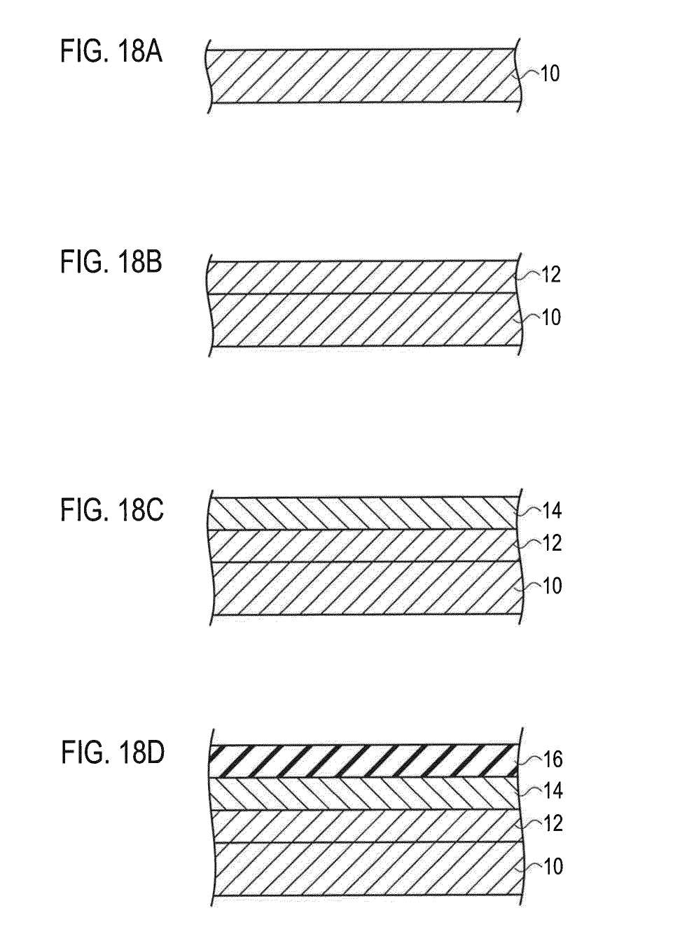

In a fabrication method of the capacitor element according to the embodiment, pre-processing of the substrate 10 is illustrated as shown in FIG. 18A, a process of forming the buffer layer 12 on the substrate 10 is illustrated as shown in FIG. 18B, a process of forming the lower electrode 14 on the buffer layer 12 is illustrated as shown in FIG. 18C, and a process of forming the dielectric layer 16 on the lower electrode 14 is illustrated as shown in FIG. 18D.

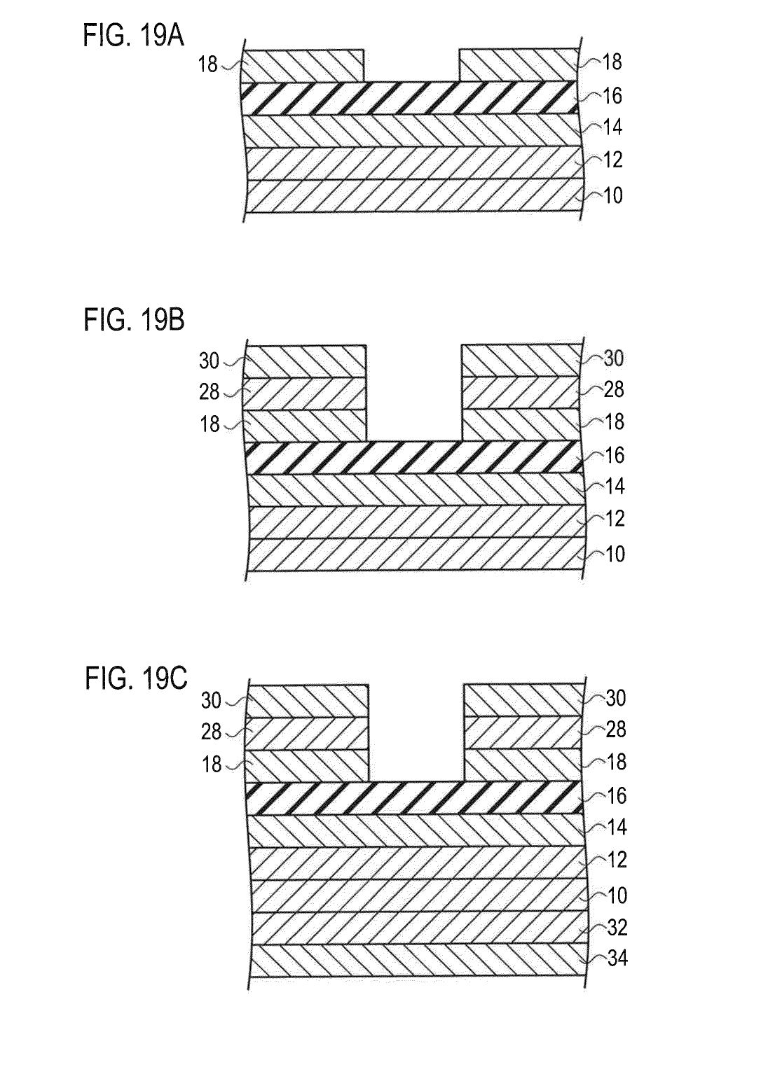

Furthermore, in the fabrication method of the capacitor element according to the embodiment, a process of pattern-forming the upper electrode 18 on the dielectric layer 16 is illustrated as shown in FIG. 19A, a process of forming the Ni layer 28 on the upper electrode 18 and forming the Ag layer 30 on the Ni layer 28 one by one is illustrated as shown in FIG. 19B, and a process of forming the Ni layer 32 on a back side surface of the substrate 10 and forming the Ag layer 34 on the Ni layer 32 one by one is illustrated as shown in FIG. 19C.

The fabrication method of the capacitor element according to the embodiment includes: pre-processing the substrate 10; forming the buffer layer 12 on the substrate 10; forming the lower electrode 14 on the buffer layer 12; forming the dielectric layer 16 on the lower electrode 14, the dielectric layer 16 composed nitride; and forming the upper electrode 18 on the dielectric layer 16.

The substrate 10 may be formed of a metallic foil.

Moreover, a substrate may be formed of a semiconductor substrate 3 (refer to FIG. 2).

Moreover, the fabrication method further includes forming the insulating layer 5 on the semiconductor substrate 3, wherein the buffer layer 12 may be formed on the insulating layer 5.

Each step of forming the buffer layer 12, the forming the lower electrode 14, forming the dielectric layer 16, and forming the upper electrode 18 may be implemented by a sputtering process.

Each sputtering process may be implemented in the same chamber.

Moreover, the sputtering process may be implemented with a roll-to-roll process.

The fabrication method may further include an assembly process of laminating a plurality of the capacitor elements formed by the above-mentioned fabrication method of the capacitor element so that the separators are respectively inserted therebetween.

Hereinafter, the fabrication method of the capacitor element according to the embodiment will now be explained in process order.

(a) Firstly, as shown in FIG. 18A, the substrate 10 composed of the metallic foil is washed as pre-processing. Organic washing and acid washing are implemented in the aforementioned washing process. The metallic foil can be formed from any one of or any laminated structure of Ti, Ni, Cu, Mo, Al, Nb, Ta, Ag, Zr, Au, Pt, W, Ir, V, stainless-steel (SUS), 42Alloy, nickel silver, and brass.
(b) Next, as shown in FIG. 18B, the buffer layer 12 is formed on the substrate 10 by the sputtering process. TiAlN, IrTa, or CuTa is applicable to the buffer layer 12, for example. Moreover, the buffer layer 12 may have an amorphous conductor.
(c) Next, as shown in FIG. 18C, the lower electrode 14 is formed on the buffer layer 12 by the sputtering process. In the embodiment, vacuum evaporation technology may be applied thereto instead of the sputtering process. In the embodiment, Cr, Mo, Al, Ta, Cu, Ti, Ni, W, or Ag is applicable to materials of the lower electrode 14, as long as it is a single metal. CuTa or TiW is applicable thereto as long as it is an alloy. Ta₂N or TIN is applicable thereto as long as it is nitride. WSi₂ or TiSi is applicable thereto as long as it is a silicide. TaB is applicable thereto as long as it is a boride.
(d) Next, as shown in FIG. 18D, the dielectric layer 16 is formed on the lower electrode 14 by the sputtering process. The dielectric layer 16 may include any one of BN, BCN, CN, BAlN, BSiN, AlN or SiN. Moreover, the dielectric layer 16 include an amorphous layer.
(e) Next, as shown in FIG. 19A, the upper electrode 18 is formed on the dielectric layer 16 by the sputtering process. In the embodiment, a shadow mask is used for the sputtering process. Moreover, vacuum evaporation technology may be applied thereto instead of the sputtering process. The upper electrode 18 can be formed using the similar material to the lower electrode 14.
(f) Next, as shown in FIG. 19B, the Ni layer 28/Ag layer 30 used as a contact metal is formed on the upper electrode 18 one by one by using plating technology. In addition, sputtering technology, vacuum evaporation technology, etc. may be applied thereto instead of the plating technology.
(g) Next, an intermediate inspection is implemented by using a probe test etc.
(h) Next, as shown in FIG. 19C, the Ni layer32/Ag layer 34 is formed on the back side surface of the substrate 10 one by one by using the plating technology. In addition, sputtering technology, vacuum evaporation technology, etc. may be applied thereto instead of the plating technology. The element capacitor is completed through the above-mentioned processes.
(i) Next, a plurality of the element capacitors are connected one by one so as to be multilayered. More specifically, the fabrication method of the capacitor element according to the embodiment may further Include an assembly process of laminating a plurality of the capacitor elements formed through the above-mentioned processes so that the separators 26 are respectively inserted therebetween.
(j) Next, external electrode terminals P, N are connected to the plurality of the element capacitors connected so as to be multilayered.
(k) Next, the capacitor element is housed in a case and then sealed with a resin.

The capacitor element according to the embodiment is completed through the above-mentioned processes.

Although a fabricating process in the case of using the semiconductor substrate 3 is also similar thereto, the substrate 10a in which the insulating layer 5 is formed on the semiconductor substrate 3 is used at a start, and then the substrate 10a is washed in the pre-processing in the same manner as that show in FIG. 18A. Organic washing and acid washing are implemented in the aforementioned washing process. The subsequent process is the same as that of above-mentioned process.

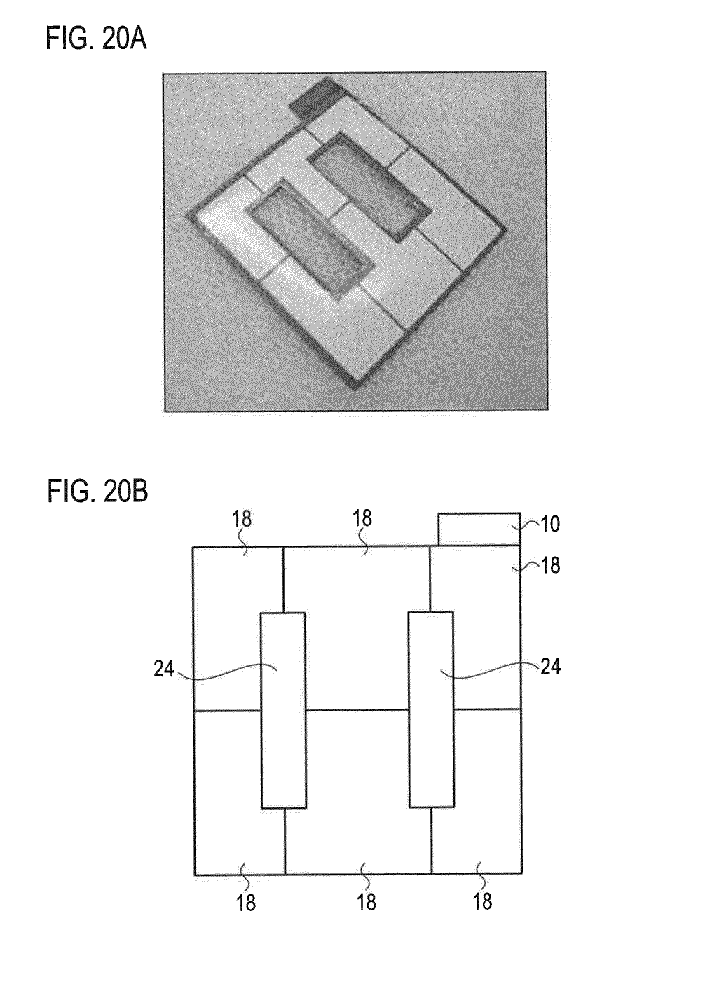

FIG. 20A shows an example of an outside surface photograph of the capacitor element according to the embodiment. FIG. 20B is a schematic front surface pattern configuration corresponding to that in FIG. 20A.

In the capacitor element according to the embodiment, the element capacitor includes two apertures 24, for example. Moreover, as shown in FIG. 20B, the upper electrode 18 may be divided into a plurality of portions.

As an example of characteristics of the prototype, an approximately 1-μF capacitor element is obtained by connecting three pieces of approximately 0.3-μF element capacitors 20₁ in series, and then connecting ten pieces thereof in parallel. For example, an approximately 600V-breakdown voltage can be designed.

Moreover, in the fabrication method of the capacitor element according to the embodiment, each step of forming the buffer layer 12, the forming the lower electrode 14, forming the dielectric layer 16, and forming the upper electrode 18 can be implemented by a sputtering process, and each sputtering process may be implemented in the same chamber. In this case, multiple times of the sputtering processes may be implemented by roll-to-roll process.

In the capacitor element according to the embodiment, it can be assembled to be completed as a device, after a depositing process for each layer by using the minimum number of times of the sputtering processes.

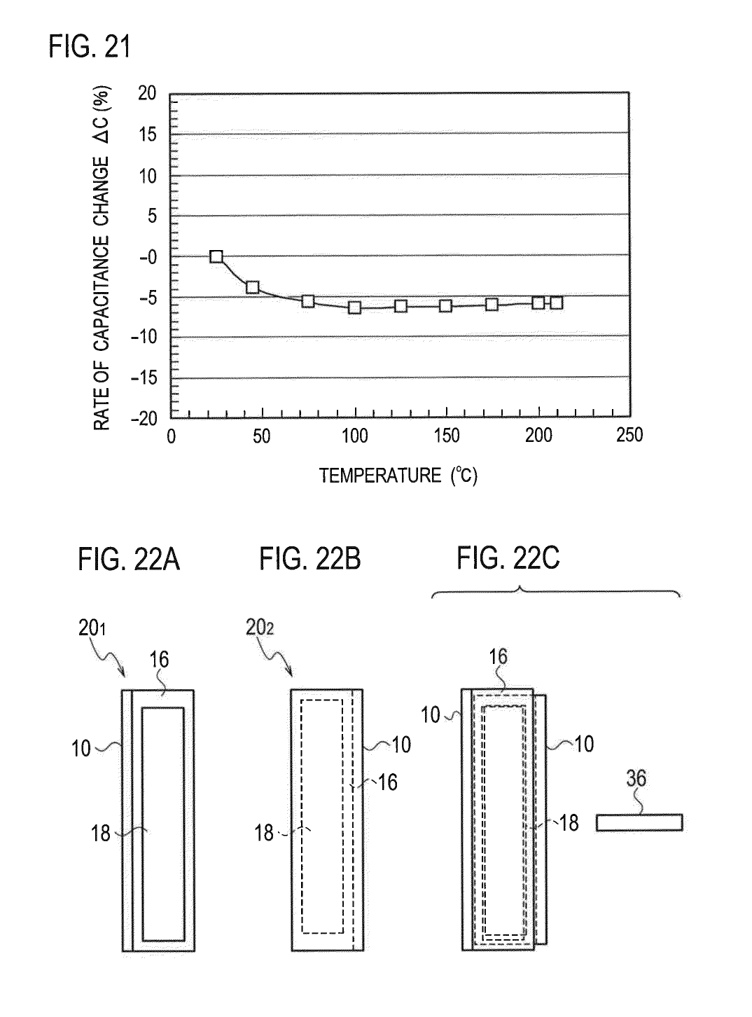

FIG. 21 shows an example of temperature characteristics of the rate of capacitance change ΔC (%), in the capacitor element according to the embodiment fabricated through the above-mentioned fabricating processes. In the embodiment, the rate of capacitance change ΔC (%) is expressed by the following equation:

ΔC(%)=(C(T)−C(RT))/C(RT) (1)

where C(T) is capacitance at temperature T, and C(RT) is capacitance at room temperature.

In the capacitor element according to the embodiment, the rate of capacitance change ΔC (%) with respect to room temperature is within a range of less than plus/minus 10%, over a wide range from room temperature to equal to or greater than 200 degrees C. As a comparative example, the rate of capacitance change ΔC (%) with respect to room temperature in an example of a ceramic capacitor is approximately minus 50% at 200 degrees C.

### (Example of Device Made by a Roll Method)

FIG. 22A shows a front surface pattern configuration of a first element capacitor 20₁ applied to an example of a device made by a roll method of the capacitor element according to the embodiment, FIG. 22B shows a back surface pattern configuration of a second element capacitor 20₂ applied thereto, and FIG. 22C is a front surface pattern configuration diagram before winding up the laminated first element capacitor 20₁ and second element capacitor 20₂ onto a core rod 36 applied thereto.

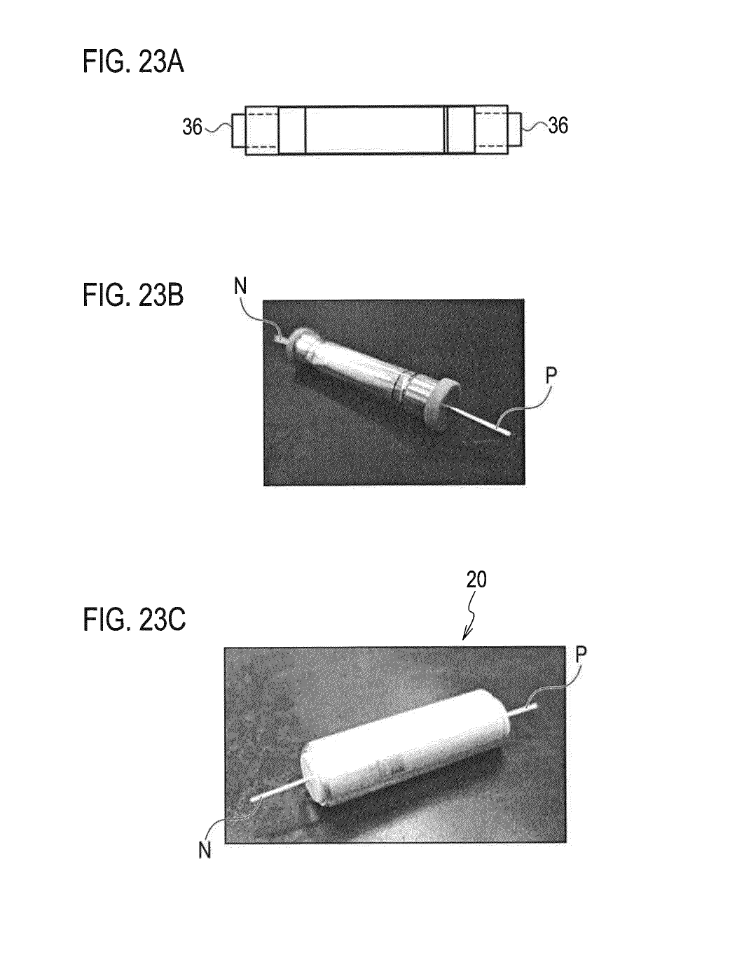

FIG. 23A shows a front surface pattern configuration after winding up the laminated first element capacitor 20₁ and second element capacitor 20₂ onto a core rod 36, FIG. 23B shows an example of an external photograph of a wound state, and FIG. 23C shows an example of an external photograph in a state where the capacitor element according to the embodiment is connected to external electrode terminals P, N, and is housed in a case.

More specifically, the capacitor element according to the embodiment includes: the first element capacitor 20₁ and the second element capacitor 20₂; and a core rod 36 for the purpose of winding up the first element capacitor 20₁ and the second element capacitor 20₂, wherein the upper electrode 18 of the first element capacitor 20₁ and the upper electrode 18 of the second element capacitor 20₂ are bonded to each other, and then the bonded first and second element capacitor 20₁, 20₁ are wound up on the core rod 36, and thereby a device can be made by a roll method.

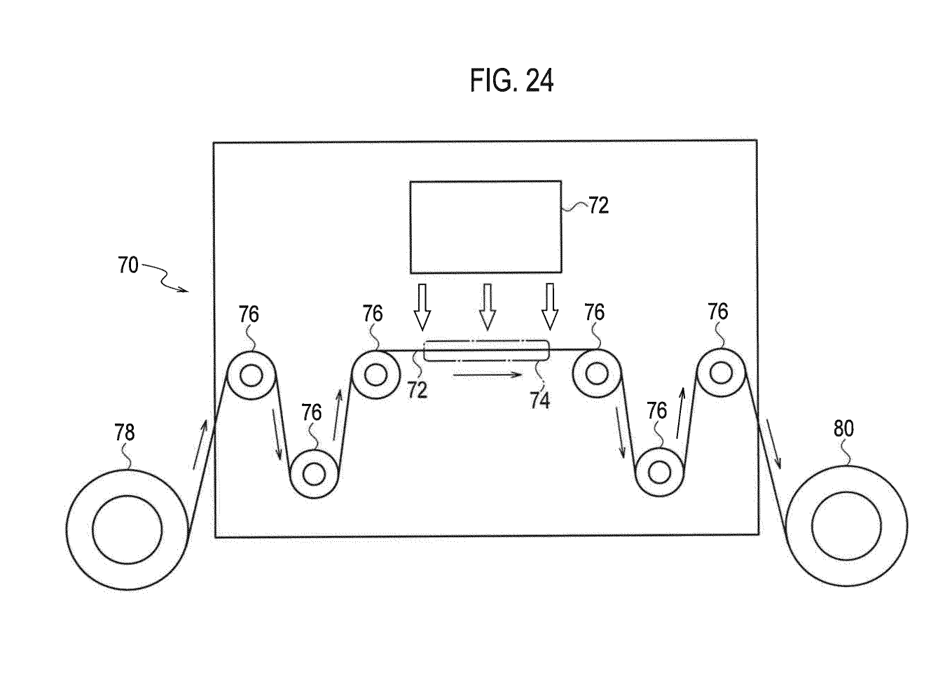

In a fabricating apparatus applicable to the fabrication method of the capacitor element according to the embodiment, FIG. 24 shows a configuration of the capacitor fabricating apparatus which can mass-produce the capacitor with a roll-to-roll method by applying the same chamber to the sputtering process.

As shown in FIG. 24, the capacitor fabricating apparatus using the roll-to-roll method applicable to the fabrication of the capacitor according to the embodiment includes: a material supply roller 78; a material winding roller 80; a plurality of tension rollers 76; a material 72 transferred via the tension rollers 76 between the material supply roller 78 and the material winding roller 80; and a vacuum chamber 70 configured to supply a target material by sputtering from the film-forming material supplying target 72, in a film formation area 74 on the material 72. In the embodiment, the sputtering process of film formation for a plurality of layers in the film formation area 74 can be implemented with the roll-to-roll process in the vacuum chamber 70.

According to the capacitor fabricating apparatus using the roll-to-roll method shown in FIG. 24, the capacitors according to the embodiment can be mass-produced since the buffer layer 12, the lower electrode 14, the dielectric layer 16, and the upper electrode 18, etc. can efficiently be formed with the roll-to-roll method.

### Application Example

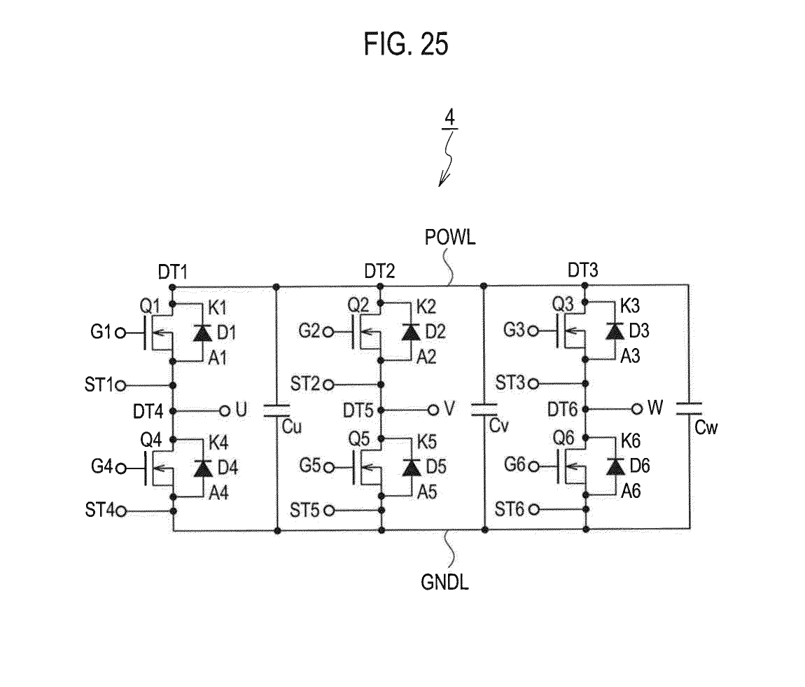

FIG. 25 shows a schematic circuit configuration of a three-phase AC inverter equipment 4 composed by arranging six pieces of the power module semiconductor devices 2. As shown in FIG. 25, the capacitor element according to the embodiments Cu, Cv, Cw are respectively connected to between power line POWL and grounding line (earthing terminal) GNDL of each of U-phase, V-phase, and W-phase half bridge inverters.

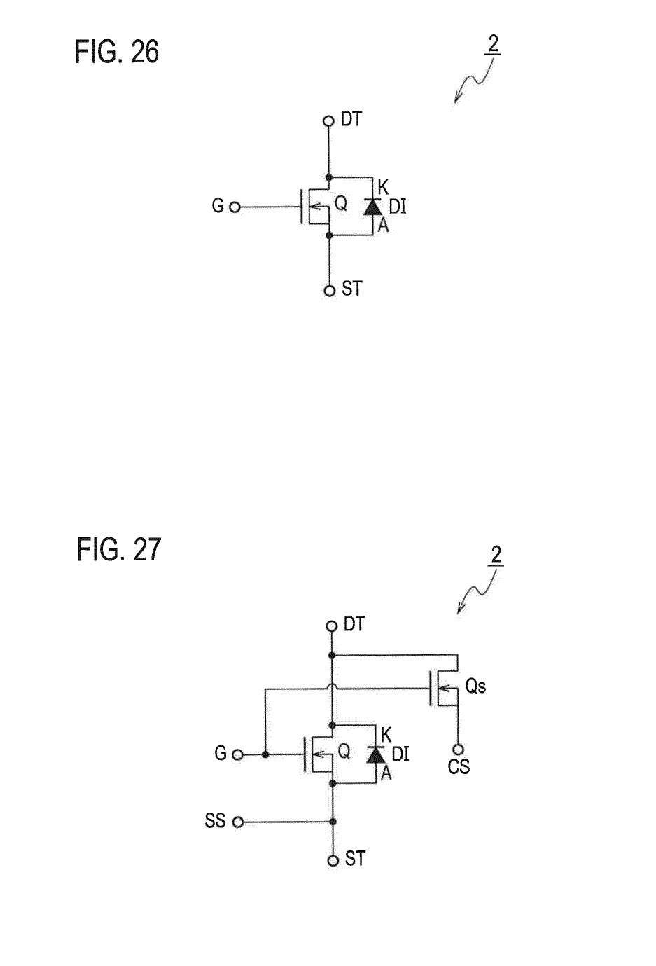

FIG. 26 is a schematic circuit representative of a 1-in-1 module, which is a power module semiconductor device 2 applicable to the three-phase AC inverter equipment 4 shown in FIG. 25. Moreover, a details circuit representation of the 1-in-1 module is represented as shown in FIG. 27.

In the configuration of the 1-in-1 module, as shown in FIG. 26, one MOSFET Q is included in one module.

The diode DI connected to the MOSFETQ inversely in parallel is shown in FIG. 27. A main electrode of the MOSFETQ is expressed with a drain terminal DT and a source terminal ST. Moreover, as shown in FIG. 27, a sense MOSFET Qs is connected to the MOSFETQ in parallel. The sense MOSFET Qs is formed as a minuteness transistor in the same chip as the MOSFET Q. In FIG. 27, reference numeral SS denotes a source sense terminal, reference numeral CS denotes a current sense terminal, and reference numeral G denotes a gate signal terminal.

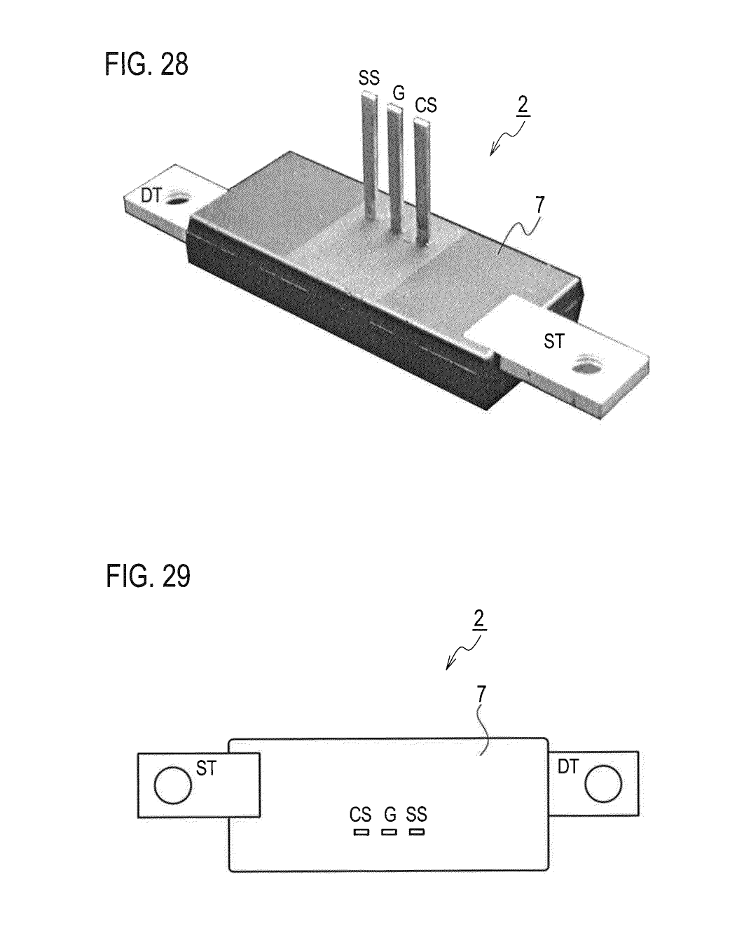

A schematic bird's-eye view configuration of the 1-in-1 module is illustrated as shown in FIG. 28. In the power module semiconductor device 2 having the straight wiring structure, the signal terminals SS, G, CS are arranged so as to be projected in a vertical direction from a resin layer 7, as shown in FIG. 28.

Moreover, FIG. 29 shows a schematic plane configuration of the power module semiconductor device 2 having the straight wiring structure.

### (Vertically Stacked Structure)

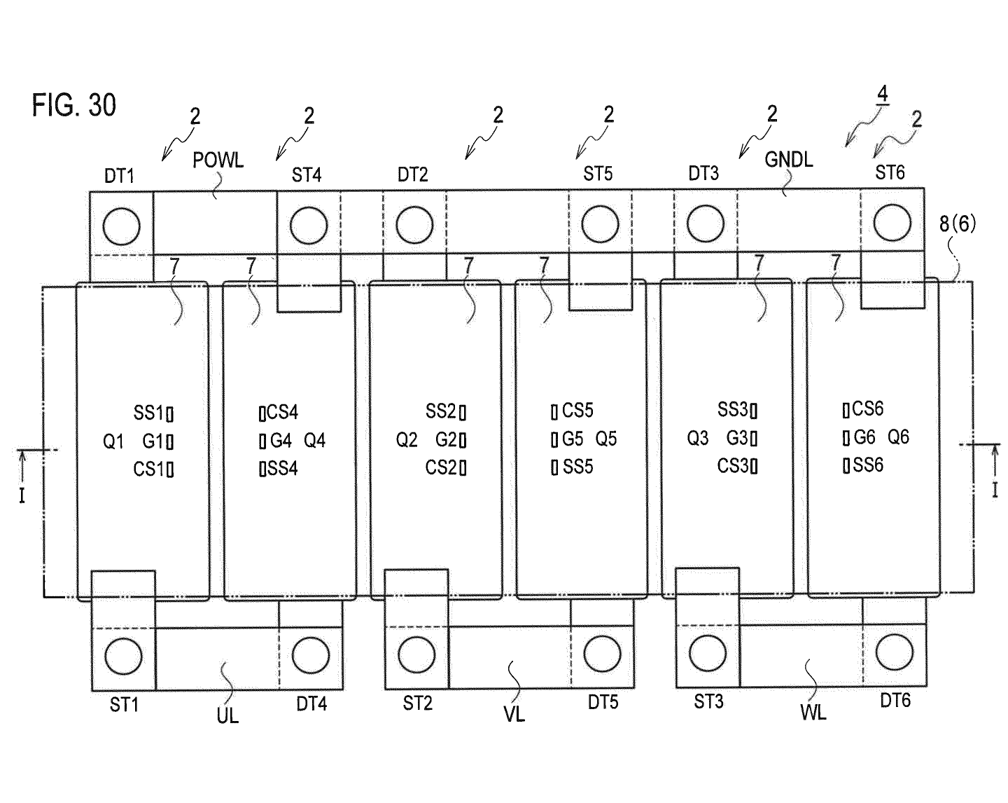

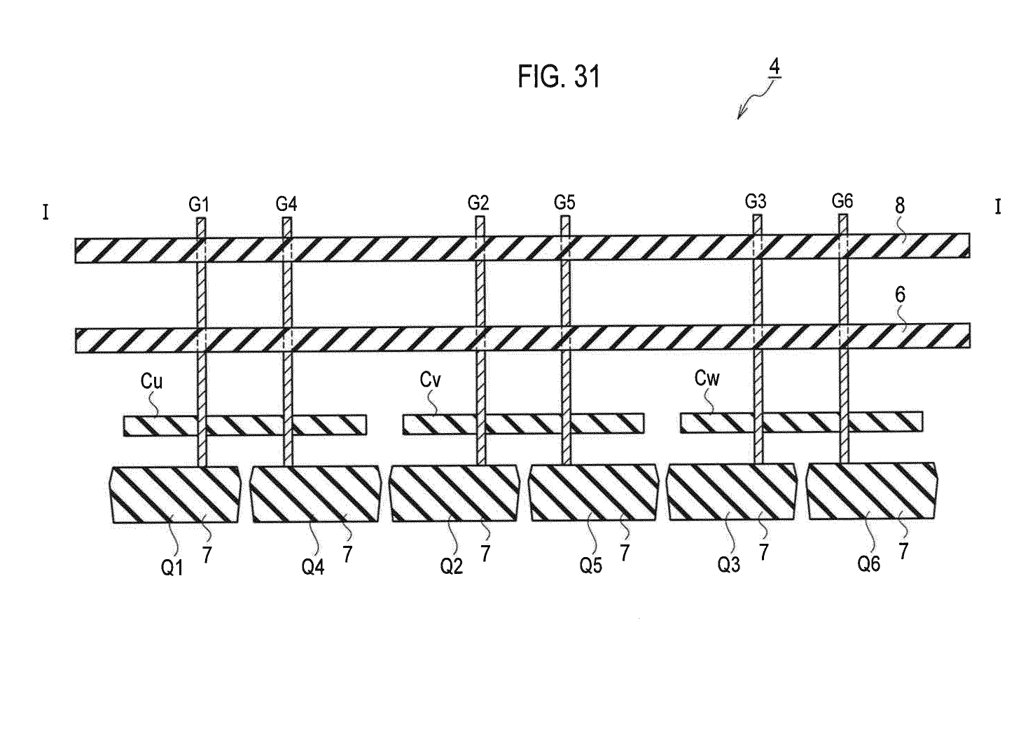

In a schematic plane configuration also including connection wiring (bus bar) electrodes (GNDL, POWL) connected between each power terminal in the three-phase AC inverter equipment 4 composed by arranging the six pieces of the power module semiconductor devices 2 having the straight wiring structure, FIG. 30 shows an example of disposing a control substrate 6 and a power source substrate 8 at an upper portion of the three-phase AC inverter equipment 4, and FIG. 31 shows a schematic cross-sectional structure taken in the line I-I of FIG. 30. Although the capacitor element Cu, Cv, Cw are omitted from FIG. 30 in order to avoid complicatedness, the capacitor element Cu, Cv, Cw are actually disposed on the power module semiconductor device 2, as shown in FIG. 31.

As shown in FIGS. 30 and 31, the three-phase AC inverter equipment 4 composed by arranging six pieces of the power module semiconductor devices 2 having the straight wiring structure includes: a control substrate 6 disposed on a plurality of the power module semiconductor devices 2 disposed in parallel, the control substrate 6 configured to control the power module semiconductor devices 2; a power source substrate 8 disposed on the plurality of the power module semiconductor devices 2 disposed in parallel, and configured to supply a power source to the power module semiconductor devices 2 and the control substrate 6; and capacitor elements Cu, Cv, Cw disposed on half bridge inverters (Q1, Q4), (Q2, Q5), (Q3, Q6) composed of every two pieces of the power module semiconductor devices 2 among the plurality of the power module semiconductor devices 2 disposed in parallel which with each other by a power module semiconductor device 2. In this case, the capacitor element according to the embodiment is applied to the capacitor elements Cu, Cv, Cw. The length of the vertical direction in which the signal terminals CS, G, SS are extended is an enough length to connect the signal terminals CS, G, SS to the control substrate 6 and the power source substrate 8. In the example shown in FIG. 31, the capacitor element Cu, Cv, Cw are disposed between the power module semiconductor device 2 and the control substrate 6, and the signal terminals CS, G, SS pass through each aperture 24 of the capacitor elements Cu, Cv, Cw.

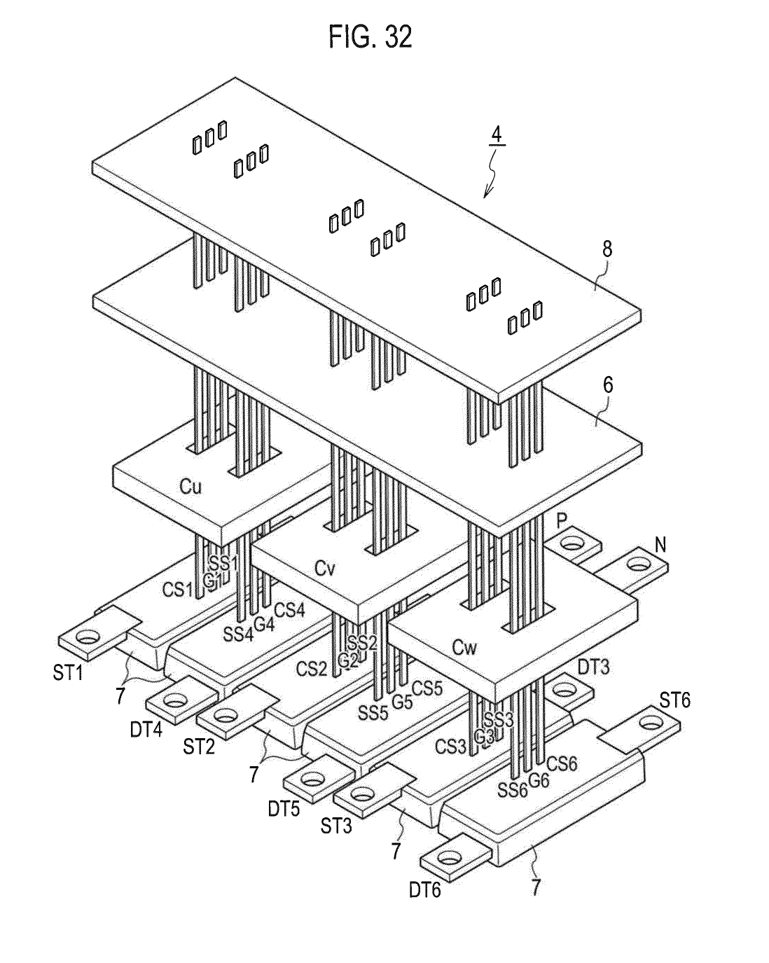

Furthermore, FIG. 32 is a schematic bird's-eye view configuration of the three-phase AC inverter 4 configured to arrange six power module semiconductor devices 2, in which the capacitor elements Cu, Cv, Cw according to the embodiment are mounted thereon, and the control substrate 6 and the power source substrate 8 are arranged thereon. As shown in FIG. 32, the signal terminals (CS1, G1, SS1), (CS2, G2, SS2), (CS3, G3, SS3), (CS4, G4, SS4), (CS5, G5, SS5), (CS6, G6, SS6) of the six pieces of the power module semiconductor devices 2 are respectively connected to the capacitor elements Cu, Cv, Cw, the control substrate 6, and the power source substrate 8 in vertical direction, thereby composing the three-phase AC inverter equipment 4. Note that detailed patterns of the control substrate 6 and the power source substrate 8 are omitted from FIG. 32 for the purpose of simplification. Moreover, although distances in a vertical direction between the power module semiconductor device 2, and the capacitor element Cu, Cv, Cw which function as a snubber capacitor, the control substrate 6, and the power source substrate 8 are respectively illustrated so as to be relatively long distances in FIG. 32 in order to clarify the details of the structure, each distance therebetween is actually shortened.

In the three-phase AC inverter equipment composed by arranging six pieces of the power module semiconductor devices 2 having the straight wiring structure, the capacitor element Cu, Cv, Cw, the control substrate, the power source substrate, the snubber capacitor C, etc. can be easily arranged in the vertically stacked structure, thereby slimming down the system.

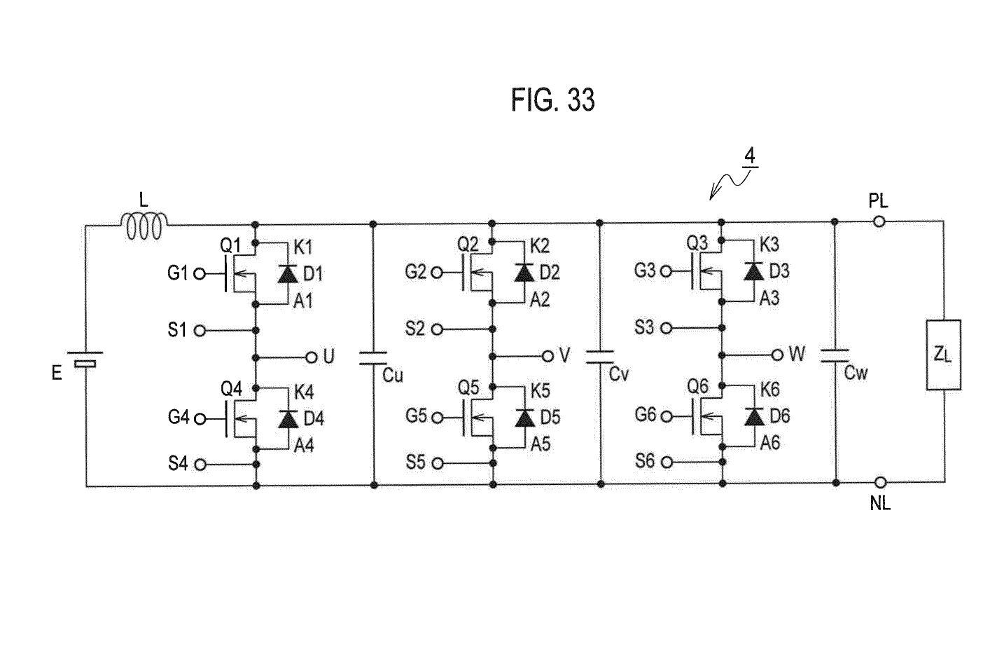

In the three-phase AC inverter equipment composed by arranging six pieces of the power module semiconductor devices 2, FIG. 33 shows a circuit configuration in which the capacitor elements Cu, Cv, Cw according to the embodiment are connected between the power line and the grounding line (earthing line) of each half bridge inverter, and load Z_{L} is connected between the power supply terminal PL and the ground terminal (earth terminal) NL. When connecting the three-phase AC inverter equipment to the power source E, large surge voltage Ldi/dt is produced by an inductance L included in a connection line due to a high switching speed of the SiC device. For example, the surge voltage Ldi/dt is expressed as follows: Ldi/dt=3×10⁹ (A/s), where a current change di=300A, and a time variation accompanying switching dt=100 ns. Although a value of the surge voltage Ldi/dt changes dependent on a value of the inductance L, the surge voltage Ldi/dt is superimposed on the power source V. This surge voltage Ldi/dt can be absorbed by the capacitor elements Cu, Cv, Cw according to the embodiment.

### (Application Examples for Applying Semiconductor Device)

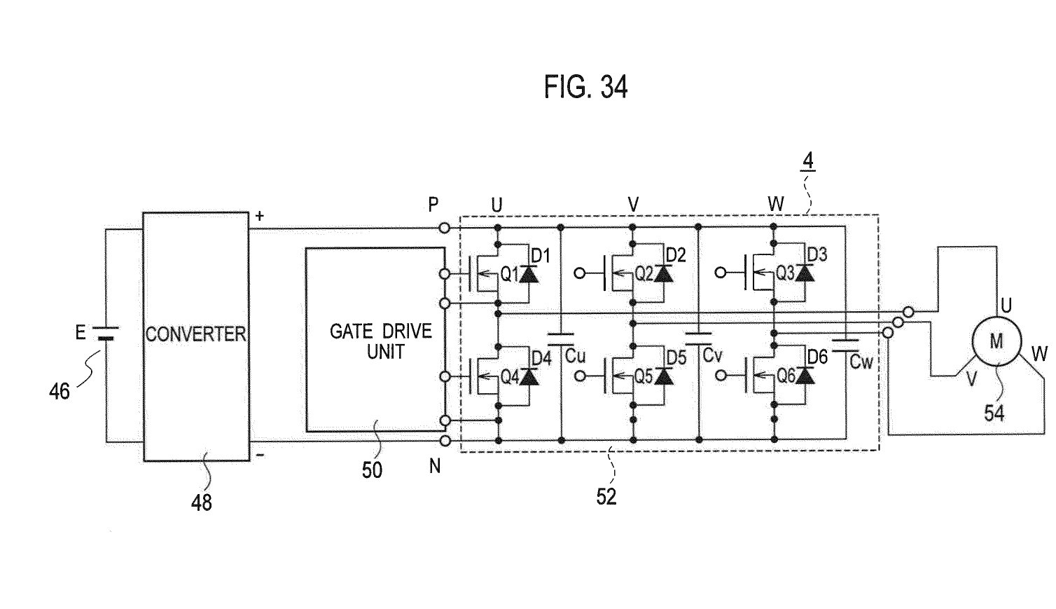

Next, there will now be explained a three-phase AC inverter composed by using the power module semiconductor device 2 with reference to FIG. 34.

As shown in FIG. 34, the three-phase AC inverter includes: a gate drive unit 50; a power module unit 52 connected to the gate drive unit 50 and a three-phase alternating current (AC) motor unit 54. U-phase, V-phase, and W-phase inverters are respectively connected to the three-phase AC motor unit 54 so as to correspond to U phase, V phase, and W phase of the three-phase AC motor unit 54, in the power module unit 52. The capacitor elements Cu, Cv, Cw according to the embodiment are respectively connected to the U-phase inverter, V-phase inverter, and -W phase inverter.

In this case, although the gate drive unit 50 is connected to the SiC MOSFETs Q1, Q4 as shown in FIG. 34, the gate drive unit 50 is similarly connected also to the SiC MOSFETs Q2, Q5 and the SiC MOSFETs Q3, Q6 (not shown in FIG. 34).

In the power module unit 52, the SiC MOSFETs Q1, Q4, and the SiC MOSFETs Q2, Q5, and the SiC MOSFETs Q3, Q6 having inverter configurations are connected between a positive terminal P and a negative terminal N of the converter 48 connected to a storage battery (E) 46. Furthermore, diodes D1-D6 are connected inversely in parallel to one another between the source and the drain of the SiC-MOSFETs Q1 to Q6.

Although the structure of single-phase inverter corresponding to U-phase portion of FIG. 34 has been explained, in the power module semiconductor device 2, the three-phase power module unit 52 can also be formed also by similarly forming V phase and W phase inverters.

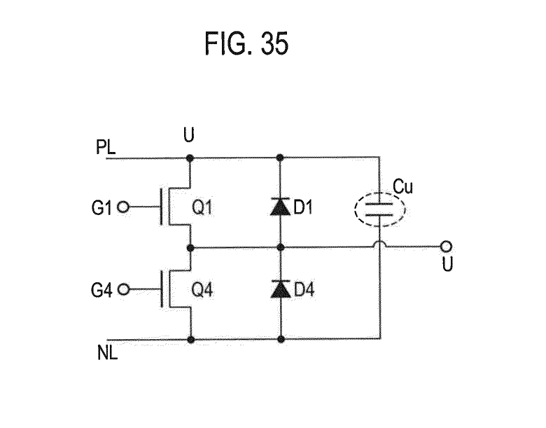

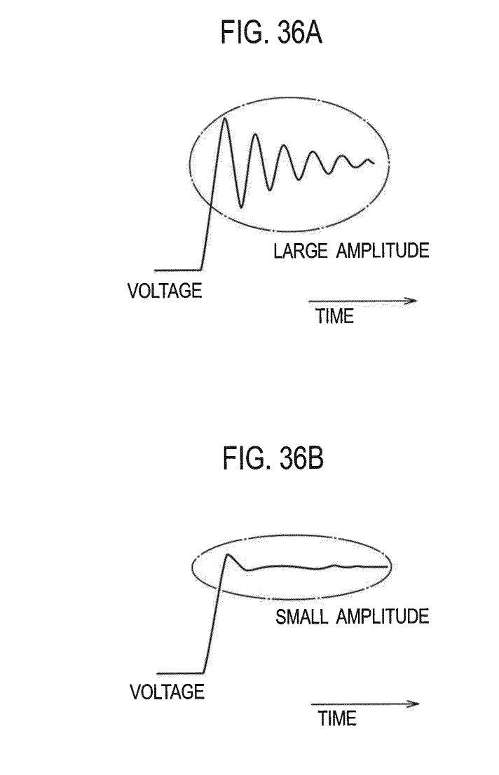

FIG. 35 shows a circuit configuration of the U-phase inverter including the capacitor element according to the embodiment Cu. Moreover, FIG. 36A shows an example of a switching voltage waveform in the state where the capacitor element according to the embodiment Cu is removed from the circuit shown in FIG. 35. FIG. 36B shows an example of a switching voltage waveform in the state where the capacitor element according to the embodiment Cu is applied thereto.

A shown in FIG. 36A, in the example of the switching voltage waveform in the state where the capacitor element according to the embodiment Cu is removed therefrom, an amplitude variation of the switching waveform is relatively large.

Meanwhile, in the example of the switching voltage waveform in the state where the capacitor element according to the embodiment Cu is applied thereto, as shown in FIG. 36B, a amplitude variation of the switching waveform can be reduced.

The capacitor element according to the embodiment is excellent in high-temperature operational stability, and can reduce a switching noise, thereby making easy a high-speed switching operation of inverter circuits. In particular, the capacitor element according to the embodiment can operate also in high-temperature operating environments in SiC inverters.

The capacitor element according to the embodiment can reduce a degradation due to a heat generation by Equivalent Series Resistance (ESR) also in large-current operations.

The capacitor element according to the embodiment is impervious to high-temperature and heat generation environments. Accordingly, if the capacitor element according to the embodiment is applied to operations of high-speed and high-current switching modules as a noise countermeasure capacitor element, the capacitor element can be disposed to nearest devices.

Since the capacitor element according to the embodiment can be disposed to nearest devices, a parasitic inductance can be reduced, and the size and weight of the capacitor element can also be reduced. Moreover, there is no necessity of providing a cooling mechanism. Accordingly, it becomes possible to demonstrate a high speed switching performance of the high-speed and high-current switching module.

### (Cutting Tool)

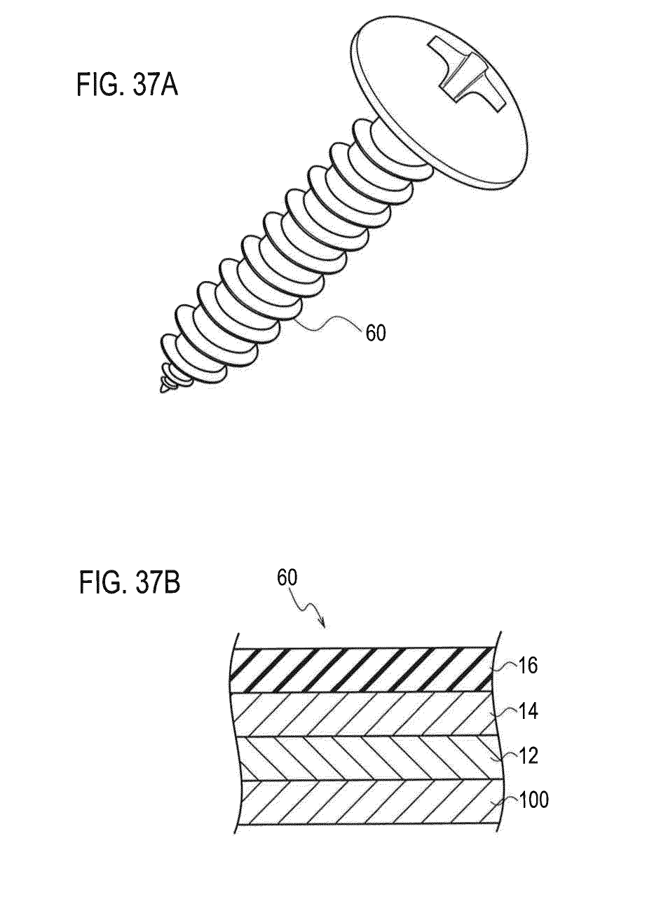

FIG. 37A shows a schematic bird's-eye view of a tap screw which is a cutting tool to which the multilayered structure according to the embodiment is applied. FIG. 37B shows a schematic cross-sectional structure of the multilayered structure applicable to the tap screw shown in FIG. 37A.

More specifically, as shown in FIGS. 37A and 37B, the cutting tool to which the multilayered structure according to the embodiment is applied, which is a structure of the tap screw, includes: a substrate material 100; a buffer layer 12 disposed on the substrate material 100; a lower electrode 14 disposed on the buffer layer 12; and a dielectric layer 16 disposed on the lower electrode 14, the dielectric layer 16 composed of nitrides.

In the embodiment, the dielectric layer 16 may include an amorphous layer. Moreover, the buffer layer 12 may include an amorphous conductor.

The buffer layer 12 may include TiAlN, IrTa, or CuTa.

Moreover, the dielectric layer 16 may include nitrogen, and may include at least one kind of boron, carbon, aluminum, or silicon.

Moreover, the dielectric layer 16 may include any one of BN, BCN, CN, BAlN, BSiN, AlN or SiN. More specifically, in the multilayered structure according to the embodiment, in the case where there is no upper electrode 18, it is utilized as an ultrahard material if the dielectric layer 16 is formed of BN or AlN, and it can also be used for surface coating of the cutting tools.

In the capacitor element according to the embodiment, serialization and parallelization of the element capacitor becomes easy, and thereby miniaturization and thickness reduction of the device van be realized.

Since nitride has physical properties, such as wide gap characteristics, covalency, oxidation-resistant, etc., the capacitor element according to the embodiment in which the dielectric layer is formed of nitride can be steadily used even at high temperature, equal to or greater than 200 degrees C., for example.

Moreover, the capacitor element according to the embodiment is suitable for a purpose of converting a noise at the time of switching into a heat to be radiated since thermal dispersion characteristics thereof are also relatively high.

As explained above, according to the embodiment, there can be provided the multilayered structure, the capacitor element, and the fabrication method of the capacitor element, each excellent in high-temperature stability.

### Other Embodiments

The embodiment has been described herein, as a disclosure including associated description and drawings to be construed as illustrative, not restrictive. This disclosure makes clear a variety of alternative embodiment, working examples, and operational techniques for those skilled in the art.

Such being the case, the embodiment covers a variety of embodiments and the like, whether described or not.

### INDUSTRIAL APPLICABILITY

The multilayered structure and the capacitor element of the embodiment can be operated in particular at high temperatures (equal to or greater than 150 degrees C.), and therefore can be applied to electronic equipment, e.g. DC-DC converters containing power capacitors or power capacitors for mobile computing devices, Electric Vehicle (EV) motor driving inverters. The multilayered structure and the capacitor element of the embodiment are further applicable to electronic equipment, e.g. online energy management, load measurement and management, energy storage management, Electric Vehicle (EV) management, solar management, and wind management.

What is claimed is:

1. A multilayered structure comprising:
a substrate;
a buffer layer disposed on the substrate;
a lower electrode disposed on the buffer layer; and
a dielectric layer disposed on the lower electrode, the dielectric layer composed of nitrides.

2. The multilayered structure according to claim 1, wherein
the dielectric layer comprises amorphous.

3. The multilayered structure according to claim 1, wherein
the buffer layer comprises an amorphous conductor.

4. The multilayered structure according to claim 1, wherein
the buffer layer comprises one selected from the group consisting of TiAlN, IrTa, and CuTa.

5. The multilayered structure according to claim 1, wherein
the dielectric layer includes nitrogen, and further includes at least one kind of boron, carbon, aluminum, and silicon.

6. The multilayered structure according to claim 1, wherein
the dielectric layer comprises one selected from the group consisting of BN, BCN, CN, BAlN, BSiN, AlN, and SiN.

7. The multilayered structure according to claim 1, wherein
the substrate comprises metallic foil.

8. The multilayered structure according to claim 1, wherein
the substrate comprises a semiconductor substrate.

9. The multilayered structure according to claim 8, further comprising
an insulating layer disposed on the semiconductor substrate, wherein
the buffer layer is disposed on the insulating layer.

10. A multilayered structure comprising:
a plurality of layers of multilayered structure being laminated, the multilayered structure comprising a substrate, a buffer layer disposed on the substrate, a lower electrode disposed on the buffer layer, a dielectric layer disposed on the lower electrode, the dielectric layer composed of nitrides.

11. A capacitor element comprising:
a multilayered structure comprising a substrate, a buffer layer disposed on the substrate, a lower electrode disposed on the buffer layer, a dielectric layer disposed on the lower electrode, the dielectric layer composed of nitrides, and an upper electrode disposed on the dielectric layer;
a first terminal electrode connected to the lower electrode; and
a second terminal electrode connected to the upper electrode.

12. The capacitor element according to claim 11, wherein
a plurality of the capacitor elements are comprised therein, and the plurality of the capacitor elements are laminated to be mutually connected in series so that separators are respectively inserted therebetween.

13. The capacitor element according to claim 11, wherein
a plurality of the capacitor elements are comprised therein, and the plurality of the capacitor elements are mutually connected in parallel.

14. A capacitor element comprising:
a first capacitor element and a second capacitor element each composed of a capacitor element, the capacitor element comprising a multilayered structure, a first terminal electrode, and a second terminal electrode, the multilayered structure comprising a substrate, a buffer layer disposed on the substrate, a lower electrode disposed on the buffer layer, a dielectric layer disposed on the lower electrode, the dielectric layer composed of nitrides, and an upper electrode disposed on the dielectric layer, the first terminal electrode connected to the lower electrode, the second terminal electrode connected to the upper electrode; and
a core rod for winding up the first capacitor element and the second capacitor element, wherein
the upper electrode of the first element capacitor and the upper electrode of the second element capacitor are bonded to each other, and then the bonded first and second element capacitor are wound up on the core rod in order to form the capacitor element.

15. A fabrication method of a capacitor element, the method comprising:
pre-processing a substrate;
forming a buffer layer on the substrate;
forming a lower electrode on the buffer layer;
forming a dielectric layer on the lower electrode, the dielectric layer composed of nitrides; and
forming an upper electrode on the dielectric layer.

16. An ultrahard cutting tool comprising:
a multilayered structure comprising a substrate material, a buffer layer disposed on the substrate material, a substrate metal disposed on the buffer layer, and a dielectric layer disposed on the substrate metal, the dielectric layer composed of nitrides, the dielectric layer used for surface coating on the ultrahard cutting tool.

17. The ultrahard cutting tool according to claim 16, wherein
the dielectric layer comprises amorphous.

18. An inverter equipment comprising:
a capacitor element comprising a multilayered structure, a first terminal electrode, and a second terminal electrode, the multilayered structure comprising a substrate, a buffer layer disposed on the substrate, a lower electrode disposed on the buffer layer, a dielectric layer disposed on the lower electrode, the dielectric layer composed of nitrides, and an upper electrode disposed on the dielectric layer, the first terminal electrode connected to the lower electrode, the second terminal electrode connected to the upper electrode, wherein
the capacitor element is mounted on the inverter equipment.

19. The inverter equipment according to claim 18 further comprising:
a plurality of power module semiconductor devices disposed in parallel;
a control substrate disposed on the power module semiconductor device, the control substrate configured to control the power module semiconductor devices; and
a power source substrate disposed on the power module semiconductor device, the power source substrate configured to supply a power source to the power module semiconductor devices and the control substrate, wherein
the capacitor element is disposed on the plurality of the power module semiconductor device disposed in parallel.

20. A capacitor fabricating apparatus comprising:
a material supply roller;
a material winding roller;
a plurality of tension rollers;
a material transferred via the tension roller between the material supply roller and the material winding roller; and
a vacuum chamber configured to supply a target material by sputtering from film-forming material supplying target in a film formation area on the material, wherein
the sputtering process of film formation for a plurality of layers in the film formation area can be implemented with the roll-to-roll process in the vacuum chamber.
